(19) United States
(12) Patent Application Publication
(10) Pub. No.: US 2024/0002678 A1
(43) Pub. Date: Jan. 4, 2024

(54) SURFACE TREATMENT AGENT AND METHOD OF PRODUCING SUBSTRATE HAVING SURFACE-TREATED LAYER

(71) Applicant: AGC Inc., Tokyo (JP)

(72) Inventors: Motoshi AOYAMA, Tokyo (JP); Masayuki HARAGUCHI, Tokyo (JP)

(73) Assignee: AGC Inc., Tokyo (JP)

(21) Appl. No.: 18/367,627

(22) Filed: Sep. 13, 2023

Related U.S. Application Data
(63) Continuation of application No. PCT/JP2022/010409, filed on Mar. 9, 2022.

(30) Foreign Application Priority Data
Mar. 17, 2021 (JP) 2021-044130

(51) Int. Cl. C09D 5/16; C09D 183/12; C09D 7/20

(52) U.S. Cl. CPC C09D 5/1675; C09D 7/20; C09D 183/12

(57) ABSTRACT

A surface treatment agent includes: a fluorine-containing compound (A) having a reactive silyl group; a compound (B); and a compound (C) selected from a compound (C1): R⁷COR⁸, a compound (C2), a compound (C3): R¹⁰—[OR¹¹]_{q}—R¹², a hydrofluoroolefin (C4) having from 3 to 8 carbon atoms, and a hydrochlorofluoroolefin (C5) having from 3 to 8 carbon atoms. 0 to 3 members of R¹ to R⁶ are fluorine-containing alkyl groups having from 1 to 3 carbon atoms, and the remaining members among R¹ to R⁶ represent hydrogen or fluorine atoms. R⁷ and R⁸ represent a fluorine-containing alkyl group having from 1 to 5 carbon atoms. R⁹ represents a residue that forms a 3- to 5-membered ring structure with the carbon atom of a carbonyl group and that has a fluorine atom. R¹⁰ and R¹² represent a fluorine-containing alkyl group having from 1 to 3 carbon atoms, q represents an integer of 1 or more, R¹¹ represents a perfluoroalkylene group having from 1 to 6 carbon atoms.

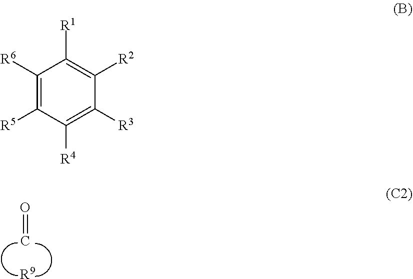

### CROSS-REFERENCE TO RELATED APPLICATIONS

This application is a Continuation of International Application No. PCT/JP2022/010409, filed on Mar. 9, 2022, which claims priority to Japanese Patent Application No. 2021-044130, filed on Mar. 17, 2021. The entire disclosure of each of the above applications is incorporated herein by reference.

### TECHNICAL FIELD

The present disclosure relates to a surface treatment agent, and a method of producing a substrate having a surface-treated layer.

### BACKGROUND ART

The fluorine-containing compound exhibits high lubricity, water and oil repellency, and the like. In a case in which a fluorine-containing compound is applied to a surface of a substrate to form a surface-treated layer, water and oil repellency, and the like are imparted to the surface of the substrate. Accordingly, fouling on the surface of the substrate may be easily wiped off, and fouling removability is improved. Among fluorine-containing compounds, a fluorine-containing ether compound having a poly(oxyperfluoroalkylene) chain in which an ether bond (—O—) is present within a perfluoroalkylene chain is excellent in removability against fouling such as oil or fat fouling.

Examples of a fluorine-containing ether compound that may be used as a component for imparting surface water and oil repellency or the like include a compound having a perfluoropolyether group and a curable site described in International Publication (WO) 2018/181936.

Examples of a method of applying a fluorine-containing compound to a surface of a substrate include vacuum deposition methods such as the physical vapor deposition (PVD) method and the chemical vapor deposition (CVD) method. The other methods include wet coating methods in which a surface treatment agent containing a fluorine-containing compound is applied to a surface of a substrate by dipping, spraying or the like, and is dried.

### SUMMARY OF INVENTION

### Technical Problem

A fluorine-containing compound is dissolved in an organic solvent and used as a surface treatment agent. Organic solvents for dissolving fluorine-containing compounds are required to reduce environmental burden. Ozone depletion potential (ODP) and global warming potential (GWP) are typical parameters representing the degree of environmental burden. Conventionally, hydrofluoroether (HFE) has been used as an organic solvent for dissolving a fluorine-containing compound. HFE has a low ODP and is an excellent organic solvent but has the disadvantage of a high GWP. Therefore, an organic solvent that may replace HFE has been desired.

Examples of an organic solvent that may replace HFE include fluorine-containing aromatic compounds. However, using a fluorine-containing aromatic compound singly may cause decreased storage stability of a surface treatment agent.

In addition, the flatness of a surface-treated layer may decline depending on the type of fluorine-containing compound and the method of applying a fluorine-containing compound to a surface of a substrate. When the flatness of a surface-treated layer declines, it may cause deterioration of appearance, decrease in light transmittance, and the like.

The present disclosure has been made in consideration of the above-described circumstances. An object of the present disclosure is to provide a surface treatment agent capable of forming a surface-treated layer having excellent storage stability and excellent flatness, and a method of producing a substrate having a surface-treated layer using the surface treatment agent.

Specific embodiments for achieving the above object are as follows.

<1> A surface treatment agent, including:
a fluorine-containing compound (A) having a reactive silyl group;
a fluorine-containing aromatic compound (B) represented by the following Formula (B); and
at least one compound (C) selected from the group consisting of a fluorine-containing ketone compound (C1) represented by the following Formula (C1), a fluorine-containing cyclic ketone compound (C2) represented by the following Formula (C2), a fluorine-containing polyether compound (C3) represented by the following Formula (C3), a hydrofluoroolefin (C4) having from 3 to 8 carbon atoms, and a hydrochlorofluoroolefin (C5) having from 3 to 8 carbon atoms.

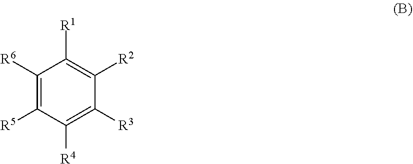

R⁷COR⁸ (C1)

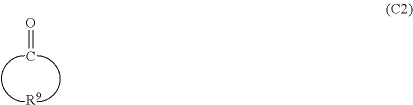

R¹⁰—[OR¹¹]_{q}—R¹² (C3)
in which, in Formula (B), each of R¹ to R⁶ independently represents a hydrogen atom, a fluorine atom, or a fluorine-containing alkyl group having from 1 to 3 carbon atoms, 0 to 3 members of R¹ to R⁶ are fluorine-containing alkyl groups, and the remaining members among R¹ to R⁶ represent hydrogen or fluorine atoms, and at least one of R¹ to R⁶ is a fluorine atom or a fluorine-containing alkyl group having from 1 to 3 carbon atoms,
in Formula (C1), each of R⁷ and R⁸ independently represents a linear, branched, or cyclic fluorine-containing alkyl group having from 1 to 5 carbon atoms,
in Formula (C2), R⁹ represents a residue that forms a 3- to 5-membered ring structure with a carbon atom of a carbonyl group and that has a fluorine atom, and R⁹ may be substituted with a fluorine-containing alkyl group having from 1 to 2 carbon atoms, and
in Formula (C3), each of R¹⁰ and R¹¹ independently represents a fluorine-containing alkyl group having from 1 to 3 carbon atoms, q represents an integer of 1 or more, R¹¹ represents a perfluoroalkylene group having from 1 to 6 carbon atoms, and in a case in which q is an integer of 2 or more, plural R's may be the same or different.

<2> The surface treatment agent according to <1>, in which a boiling point of the fluorine-containing aromatic compound (B) at atmospheric pressure is from 80 to 220° C.

<3> The surface treatment agent according to <1> or <2>, in which a mass-based ratio of the fluorine-containing aromatic compound (B) to a total of the compound (C) is from 5/95 to 90/10.

<4> The surface treatment agent according to <1> or <2>, in which:
the compound (C) includes the fluorine-containing ketone compound (C1), and
a mass-based ratio of the fluorine-containing aromatic compound (B) to the fluorine-containing ketone compound (C1) is from 10/90 to 90/10.

<5> The surface treatment agent according to <1> or <2>, in which:
the compound (C) includes the fluorine-containing cyclic ketone compound (C2), and
a mass-based ratio of the fluorine-containing aromatic compound (B) to the fluorine-containing cyclic ketone compound (C2) is from 10/90 to 90/10.

<6> The surface treatment agent according to <1> or <2>, in which:
the compound (C) includes the fluorine-containing polyether compound (C3), and
a mass-based ratio of the fluorine-containing aromatic compound (B) to the fluorine-containing polyether compound (C3) is from 12/88 to 90/10.

<7> The surface treatment agent according to <1> or <2>, in which:
the compound (C) includes the hydrofluoroolefin (C4), and
a mass-based ratio of the fluorine-containing aromatic compound (B) to the hydrofluoroolefin (C4) is from 10/90 to 90/10.

<8> The surface treatment agent according to <1> or <2>, in which:
the compound (C) includes the hydrochlorofluoroolefin (C5), and
a mass-based ratio of the fluorine-containing aromatic compound (B) to the hydrochlorofluoroolefin (C5) is from 10/90 to 90/10.

<9> The surface treatment agent according to any one of <1> to <8>, in which at least one fluorine-containing alkyl group represented by R⁷ or R⁸ in Formula (C1) is a branched fluorine-containing alkyl group.

<10> The surface treatment agent according to <9>, in which both fluorine-containing alkyl groups represented by R⁷ and R⁸ in Formula (C1) are branched fluorine-containing alkyl groups.

<11> The surface treatment agent according to <9> or <10>, in which the branched fluorine-containing alkyl group has a branched structure at α-carbon.

<12> The surface treatment agent according to any one of <1> to <11>, in which a boiling point of the fluorine-containing polyether compound (C3) at atmospheric pressure is from 50 to 220° C.

<13> The surface treatment agent according to any one of <1> to <12>, in which a number average molecular weight of the fluorine-containing polyether compound (C3) is from 300 to 1,000.

<14> The surface treatment agent according to any one of c <1> to <13>, in which the fluorine-containing polyether compound (C3) includes a perfluoropolyether compound.

<15> The surface treatment agent according to any one of <1> to <14>, in which the fluorine-containing ketone compound (C1) includes a perfluoroketone compound.

<16> The surface treatment agent according to any one of <1> to <15>, in which the fluorine-containing cyclic ketone compound (C2) includes a perfluorocyclic ketone compound.

<17> The surface treatment agent according to any one of <1> to <16>, in which the hydrofluoroolefin (C4) is at least one selected from the group consisting of (E)-1,1,1,4,4,4-hexafluoro-2-butene, (Z)-1,1,1,4,4,4-hexafluoro-2-butene, 2,4,4,4-tetrafluoro-1-butene, (E)-1,1,1,3-tetrafluoro-2-butene, 1,3,3,4,4,5,5-heptafluorocyclopentene, 3,3,4,4,5,5-hexafluorocyclopentene, (E)-1,1,1,4,4,5,5,5-octafluoro-2-pentene, and 1,1,1,2,2,5,5,6,6,7,7,7-dodecafluoro-3-heptene.

<18> The surface treatment agent according to any one of <1> to <17>, in which the hydrochlorofluoroolefin (C5) is at least one selected from the group consisting of (Z)-1-chloro-3,3,3-trifluoropropene, (E)-1-chloro-3,3,3-trifluoropropene, (Z)-1-chloro-2,3,3-trifluoropropene, 1,3-dichloro-2,3,3-trifluoropropene, (Z)-1-chloro-2,3,3,3-tetrafluoropropene, 1-chloro-2,3,3,4,4,5,5-heptafluorocyclopentene, 1,3-dichloro-2,3,3-trifluoropropene, 1,2-dichloro-3,3-difluoropropene, and 1,2-dichloro-3,3,3-trifluoropropene.

<19> A method of producing a substrate having a surface-treated layer; including:
coating a surface of a substrate with the surface treatment agent according to any one of <1> to <18>; and
drying the surface treatment agent.

<20> The method of producing a substrate having a surface-treated layer according to <19>, in which a surface material of the substrate is a metal, a resin, a glass, a ceramic, or a composite material thereof.

### Advantageous Effects of Invention

According to the present disclosure, it is possible to provide a surface treatment agent capable of forming a surface-treated layer having excellent storage stability and excellent flatness, and a method of producing a substrate having a surface-treated layer using the surface treatment agent.

### DESCRIPTION OF EMBODIMENTS

A detailed description will be given below of embodiments for implementing the present disclosure. However, the present disclosure is not limited to the following embodiments. In the following embodiments, the constituent elements (including element steps and the like) are not essential unless otherwise specified. The same applies to numerical values and their ranges, which do not limit the present disclosure.

In the present disclosure, the numerical range indicated using “to” includes the numerical values before and after “to” as the minimum and maximum values, respectively.

In the present disclosure, atmospheric pressure refers to 101.3 kPa.

In the present disclosure, an unit represented by Formula (1) is referred to as “unit (1).” Units represented by other formulas are similarly described. A group represented by Formula (2) is referred to as “group (2).” Groups represented by other formulas are similarly described. A compound represented by Formula (3) is referred to as “compound (3).” Compounds represented by other formulas are similarly described.

In the present disclosure, in a case in which an “alkylene group may have a group A,” the alkylene group may have a group A between carbon-carbon atoms therein, or may have a group A at the end thereof as represented by “alkylene group-group A-.”

The terms used in the present disclosure have the following meanings.

The term “divalent organopolysiloxane residue” refers to a group represented by the following formula. In the following formula, each of R^{x} is independently an alkyl group (preferably having from 1 to 10 carbon atoms) or a phenyl group. In addition, g1 is an integer of 1 or more, preferably an integer from 1 to 9, more preferably an integer from 1 to 4.

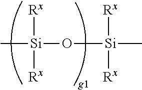

The term “silphenylene structure group” refers to a group represented by —Si(R^{y})₂PhSi(R^{y})₂—, in which Ph is a phenylene group, each of R is independently a monovalent organic group. R^{y} is preferably an alkyl group (preferably having from 1 to 10 carbon atoms).

The term “dialkylsilylene group” refers to a group represented by —Si(R^{z})₂—, in which each of R^{z} is independently an alkyl group (preferably having from 1 to 10 carbon atoms).

The “number average molecular weight” (Mn) of a compound is calculated by ¹H-NMR and ¹⁹F-NMR to determine the number (average value) of oxyfluoroalkylene groups based on the terminal group.

In the present disclosure, a number of carbon atoms means a total number of carbon atoms contained in a group as a whole. In a case in which the group does not have a substituent, it denotes a number of carbon atoms forming the structure of the group. In a case in which the group has a substituent, it denotes a total number of carbon atoms forming the structure of the group plus a number of carbon atoms in the substituent.

[Surface Treatment Agent]

The surface treatment agent in the present disclosure contains a fluorine-containing compound (A) having a reactive silyl group, a fluorine-containing aromatic compound (B) represented by Formula (B), and at least one compound (C) selected from the group consisting of a fluorine-containing ketone compound (C1) represented by Formula (C1), a fluorine-containing cyclic ketone compound (C2) represented by Formula (C2), a fluorine-containing polyether compound (C3) represented by Formula (C3), a hydrofluoroolefin having from 3 to 8 carbon atoms (C4), and a hydrochlorofluoroolefin having from 3 to 8 carbon atoms (C5).

Hereinafter, a fluorine-containing compound (A) having a reactive silyl group is sometimes referred to as compound (A), a fluorine-containing aromatic compound (B) is sometimes referred to as compound (B), a fluorine-containing ketone compound (C1) is sometimes referred to as compound (C1), a fluorine-containing cyclic ketone compound (C2) is sometimes referred to as compound (C2), a fluorine-containing polyether compound (C3) is sometimes referred to as compound (C3), a hydrofluoroolefin (C4) is sometimes referred to as compound (C4), and a hydrochlorofluoroolefin (C5) is sometimes referred to as compound (C5).

The surface treatment agent in the present disclosure is suitably used as an antifoulant for exerting water and oil repellency.

According to the present disclosure, a surface treatment agent capable of forming a surface-treated layer having excellent storage stability and excellent flatness is obtained. Although the reason why the surface treatment agent in the present disclosure can form a surface-treated layer having the above effects is unclear, it is presumed as follows.

The surface treatment agent contains a compound (A), and a compound (B) and a compound (C) as a solvent for dissolving the compound (A).

To synthesize a compound (A), a metal element compound containing a representative element such as Sn, a transition metal such as Pt and the like may be used. Such metal elements may be contained as impurities in the compound (A). In addition, unreacted raw materials, by-products, and the like used in the synthesis of the compound (A) may remain as impurities in the compound (A). These impurities may be one of the causes of declined flatness of the surface-treated layer.

Although the compound (B) is an excellent organic solvent with low environmental burden, in a case in which the compound (B) is used singly as a solvent for dissolving the compound (A), the storage stability of the surface treatment agent may decrease. To improve the storage stability of the surface treatment agent, the combination use of a solvent other than the compound (B) is desirable. As a result of intensive studies, the present inventors found a compound (C) that is suitable for improving the storage stability of the surface treatment agent and that can be used by mixing with the compound (B).

In addition, by further adding the compound (B) and the compound (C) as a solvent, it is speculated that the use of the compound (B) as a solvent improves the solubility of various impurities that may be contained in the surface treatment agent, and thus the generation of aggregates derived from impurities is likely to be suppressed. As a result, it is presumed that the generation of unevenness due to the aggregates of impurities in the surface-treated layer is suppressed, and thus a surface-treated layer having excellent flatness can be formed.

The surface treatment agent in the present disclosure contains the compound (A), the compound (B) and the compound (C), and may contain other components, if necessary.

Each component constituting the surface treatment agent in the present disclosure will be described in detail below.

<Compound (A)>

The compound (A) is a fluorine-containing compound having a reactive silyl group, which is preferably a fluorine-containing ether compound having a reactive silyl group and a poly(oxyfluoroalkylene) chain, from the viewpoint that the surface-treated layer has more excellent water and oil repellency.

The poly(oxyfluoroalkylene) chain contains plural units represented by Formula (1).

(OX) (1)

X is a fluoroalkylene group having one or more fluorine atoms.

A number of carbon atoms of the fluoroalkylene group is preferably from 2 to 6, more preferably from 2 to 4, from the viewpoint that the surface-treated layer has more excellent weather resistance and corrosion resistance.

The fluoroalkylene group may be linear or branched. From the viewpoint that the surface-treated layer has excellent abrasion resistance, a linear fluoroalkylene group is preferable. From the viewpoint that the surface-treated layer has an excellent low abrasion property, a branched fluoroalkylene group is preferable. A linear fluoroalkylene group, a branched fluoroalkylene group, and any combination thereof may be selected depending on the desired properties, if appropriate.

A number of fluorine atoms of the fluoroalkylene group is preferably from 1 to 2 times, more preferably from 1.7 to 2 times, the number of carbon atoms from the viewpoint that the surface-treated layer has more excellent corrosion resistance.

The fluoroalkylene group may be a group in which all hydrogen atoms in a fluoroalkylene group are substituted with fluorine atoms (perfluoroalkylene group).

Specific examples of unit (1) include —OCHF—, —OCF₂CHF—, —OCHFCF₂—, —OCF₂CH₂—, —OCH₂CF₂—, —OCF₂CF₂CHF—, —OCHFCF₂CF₂—, —OCF₂CF₂CH₂—, —OCH₂CF₂CF₂—, —OCF₂CF₂CF₂CH₂—, —OCH₂CF₂CF₂CF₂—, —OCF₂CF₂CF₂CF₂CH₂—, —OCH₂CF₂CF₂CF₂CF₂—, —OCF₂CF₂CF₂CF₂CF₂CH₂—, —OCH₂CF₂CF₂CF₂CF₂CF₂—, —OCF₂—, —OCF₂CF₂—, —OCF₂CF₂CF₂—, —OCF(CF₃)CF₂—, —OCF₂CF₂CF₂CF₂—, —OCF(CF₃)CF₂CF₂—, —OCF₂CF₂CF₂CF₂CF₂—, —OCF₂CF₂CF₂CF₂CF₂CF₂—.

A number of repetitions “m” of unit (1) contained in the poly(oxyfluoroalkylene) chain is 2 or more, preferably an integer from 2 to 200, more preferably an integer from 5 to 150, still more preferably an integer from 5 to 100, and particularly preferably an integer from 5 to 50. The number of repetitions “m” of the unit (1) may be 10 or more.

The poly(oxyfluoroalkylene) chain may include two or more kinds of units (1). Examples of two or more kinds of units (1) include two or more kinds of units (1) with different numbers of carbon atoms, two or more kinds of units (1) with a difference in the presence or absence of a side chain or type of a side chain, two or more kinds of units (1) with different numbers of fluorine atoms, two or more kinds of units (1) with a difference in conformation (linear/branched), and any combination thereof.

The binding order of two or more kinds of (OX) is not limited and may be arranged randomly, alternately, or in blocks.

It is preferable that the poly(oxyfluoroalkylene) chain is a poly(oxyfluoroalkylene) chain mainly containing units (1) that are oxyperfluoroalkylene groups from the viewpoint of forming a film having excellent water and oil repellency. In a poly(oxyfluoroalkylene) chain represented by (OX)ₘ, a proportion of the number of units (1) that are oxyperfluoroalkylene groups with respect to a total number m of units (1) is preferably from 50 to 100%, more preferably from 80 to 100%, and still more preferably from 90 to 100%.

As the poly(oxyfluoroalkylene) chain, a poly(oxyperfluoroalkylene) chain and a poly(oxyperfluoroalkylene) chain having one or two oxyfluoroalkylene units having a hydrogen atom at one of or each of the ends are more preferable.

As (OX)ₘ that represents a poly(oxyfluoroalkylene) chain, (OCHₘₐF₍₂₋ₘₐ₎)ₘ₁₁(OC₂H_{mb}F_{(4-mb)})ₘ₁₂(OC₃H_{mc}F_{(6-mc)})ₘ₁₃(OC₄H_{md}F_{(8-md)})ₘ₁₄(OC₅HₘₑF₍₁₀₋ₘₑ₎)ₘ₁₅(OC₆H_{mf}F_{(12-mf)})ₘ₁₆ is preferable.

ma is 0 or 1, mb is an integer from 0 to 3, me is an integer from 0 to 5, md is an integer from 0 to 7, me is an integer from 0 to 9, and mf is an integer from 0 to 11.

Each of m11, m12, m13, m14, m15, and m16 are independently an integer of 0 or more, preferably 100 or less.

m11+m12+m13+m14+m15+m16 is an integer of 2 or more, preferably an integer from 2 to 200, more preferably an integer from 5 to 150, still more preferably an integer from 5 to 100, and particularly preferably an integer from 5 to 50. m11+m12+m13+m14+m15+m16 may be 10 or more.

Among them, m12 is preferably an integer of 2 or more, more preferably an integer from 2 to 200.

In addition, C₃H_{mc}F_{(6-mc)}, C₄H_{md}F_{(8-md)}, C₅HₘₑF₍₁₀₋ₘₑ₎, and C₆H_{mf}F_{(12-mf)} may be a linear or branched group or any combination of a linear group and a branched group. From the viewpoint that the surface-treated layer has more excellent abrasion resistance, a linear group is preferable. From the viewpoint that the surface-treated layer has a more excellent low abrasion property, a branched group is preferable.

The above formula represents the type and number of units, not the arrangement of the units. In other words, m11 to m16 each represent the number of units. For example, (OCHₘₐF₍₂₋ₘₐ₎)ₘ₁₁ does not represent a block of (OCHₘₐF₍₂₋ₘₐ₎) with m11 consecutive units. Similarly, the order in which (OCHₘₐF₍₂₋ₘₐ₎) to (OC₆H_{mf}F_{(12-mf)}) are described does not mean that they are arranged in that order.

In the above formula, in a case in which two or more of m11 to m16 are not 0 (i.e., a case in which (OX)ₘ is composed of two or more kinds of units), the arrangement of different units may be any of random arrangement, alternating arrangement, block arrangement, and any combination of these arrangements.

Each of the above-described units may also be different in a case in which two or more units thereof are contained. For example, in a case in which m11 is 2 or more, plural (OCHₘₐF₍₂₋ₘₐ₎) may be the same or different.

As the reactive silyl group, a group represented by Formula (2) is preferable.

—Si(R)ₙL₃₋ₙ (2)

A number of Group (2) contained in the compound (A) is 1 or more, and from the viewpoint that the surface-treated layer has more excellent abrasion resistance, it is preferably 2 or more, more preferably from 2 to 10, still more preferably from 2 to 5, and particularly preferably 2 or 3.

In a case in which plural Groups (2) are present in one molecule, plural Groups (2) may be the same or different. It is preferable that the Groups (2) are the same from the viewpoint of the availability of raw materials and the ease of producing a compound (A).

R is a monovalent hydrocarbon group, preferably a monovalent saturated hydrocarbon group. A number of carbon atoms of R is preferably from 1 to 6, more preferably from 1 to 3, and still more preferably from 1 to 2.

L is a hydrolyzable group or a hydroxyl group.

A hydrolyzable group is a group that becomes a hydroxyl group through a hydrolysis reaction. In other words, a hydrolyzable silyl group represented by Si-L becomes a silanol group represented by Si—OH through a hydrolysis reaction. The silanol group further reacts between silanol groups to form an Si—O—Si bond. Furthermore, the silanol group undergoes a dehydration condensation reaction with a hydroxyl group present on a surface of a substrate such that a substrate-O—Si bond may be formed.

Specific examples of a hydrolyzable group include an alkoxy group, an aryloxy group, a halogen atom, an acyl group, an acyloxy group, and an isocyanate group (—NCO). The alkoxy group is preferably an alkoxy group having from 1 to 4 carbon atoms. The aryloxy group is preferably an aryloxy group having from 3 to 10 carbon atoms. Note that a heteroaryl group is included as the aryl group of the aryloxy group. The halogen atom is preferably chlorine atom. The acyl group is preferably an acyl group having from 1 to 6 carbon atoms. The acyloxy group is preferably an acyloxy group having from 1 to 6 carbon atoms.

L is preferably an alkoxy group having from 1 to 4 carbon atoms or a halogen atom from the viewpoint of the ease of producing compound (A). L is preferably an alkoxy group having from 1 to 4 carbon atoms from the viewpoint that the compound (A) has more excellent storage stability and less outgassing during coating, more preferably an ethoxy group in a case in which long-term storage stability of compound (A) is required, and more preferably a methoxy group in a case in which a short reaction time after coating is required.

n is an integer from 0 to 2.

n is preferably 0 or 1, more preferably 0. The presence of plural Ls further improves adhesiveness of a substrate to a surface-treated layer.

In a case in which n is 1 or less, plural Ls present in one molecule may be the same or different. It is preferable that plural Ls are the same from the viewpoint of the availability of raw materials and the ease of producting compound (A). In a case in which n is 2, plural Rs present in one molecule may be the same or different. It is preferable that plural Rs are the same from the viewpoint of the availability of raw materials and the ease of producting compound (A).

The compound (A) is preferably a compound represented by Formula (3) from the viewpoint that the surface-treated layer has more excellent water and oil repellency and abrasion resistance.

[A-(OX)ₘ—O-]ⱼZ[—Si(R)ₙL₃₋ₙ]_{g} (3)

A is a perfluoroalkyl group or -Q[-Si(R)ₙL₃₋ₙ]k.

A number of carbon atoms in a perfluoroalkyl group is preferably from 1 to 20, more preferably from 1 to 10, still more preferably from 1 to 6, and particularly preferably from 1 to 3 from the viewpoint that the surface-treated layer becomes more excellent abrasion resistance.

The perfluoroalkyl group may be linear or branched.

Note that in a case in which A is -Q[-Si(R)ₙL₃₋ₙ]ₖ, j is 1.

Example of the perfluoroalkyl group includes CF₃—, CF₃CF₂—, CF₃CF₂CF₂—, CF₃CF₂CF₂CF₂—, CF₃CF₂CF₂CF₂CF₂—, CF₃CF₂CF₂CF₂CF₂CF₂—, CF₃CF(CF₃)—, or the like.

The perfluoroalkyl group is preferably CF₃—, CF₃CF₂—, or CF₃CF₂CF₂—, from the viewpoint that the surface-treated layer has more excellent water and oil repellency

Q is a (k+1)-valent linking group. As described later, k is an integer from 1 to 10. Thus, Q may be a 2- to 11-valent linking group.

Q is not limited as long as it does not impair the abrasion resistance of the surface-treated layer, for example, includes an alkylene group that may have an etheric oxygen atom or a divalent organopolysiloxane residue, a carbon atom, a nitrogen atom, a silicon atom, a 2- to 8-valent organopolysiloxane residue, Groups (g2-1) to (g2-9), and Groups (g3-1) to (g3-9).

The definitions of R, L, n, X and m are given above.

Z is a (j+g)-valent linking group.

Z is not limited as long as it does not impair the abrasion resistance of the surface-treated layer, for example, includes an alkylene group that may have an etheric oxygen atom or a divalent organopolysiloxane residue, a carbon atom, a nitrogen atom, a silicon atom, a 2- to 8-valent organopolysiloxane residue, Groups (g2-1) to (g2-9), and Groups (g3-1) to (g3-9).

j is an integer 1 or more, preferably an integer from 1 to 5 from the viewpoint that the surface-treated layer has more excellent water and oil repellency, and more preferably 1 from the viewpoint of the ease of producting Compound (3).

g is an integer 1 or more, preferably an integer from 2 to 4, more preferably 2 or 3, and still more preferably 3, from the viewpoint that the surface-treated layer becomes more excellent abrasion resistance.

Compound (3) is preferably Compound (3-11), Compound (3-21) and Compound (3-31), from the viewpoint that the surface-treated layer has more excellent initial water contact angle and excellent abrasion resistance. Among them, Compound (3-11) and Compound (3-21) are particularly excellent in initial water contact angle, and Compound (3-31) is particularly excellent in abrasion resistance.

R^{f1}—(OX)ₘ—O—Y¹¹[—Si(R)ₙL₃₋ₙ]_{g1} (3-11)

[R^{f2}—(OX)ₘ—O-]ⱼ₂Y²¹[—Si(R)ₙL₃₋ₙ]_{g2} (3-21)

[L₃₋ₙ(R)ₙSi-]ₖ₃Y³²—(OX)ₘ—O—Y³¹[—Si(R)ₙL₃₋ₙ]_{g3} (3-31)

In Formula (3-11), X, m, R, n and L have the same definitions as X, m, R, n and L in Formula (3).

R^{f1} is perfluoroalkyl group, and preferred embodiments and specific examples of perfluoroalkyl groups are as described above.

Y¹¹ is a (g1+1)-valent linking group, and specific example thereof is the same as Z in Formula (3).

g1 is an integer 2 or more, preferably an integer from 2 to 15, more preferably an integer from 2 to 4, still more preferably 2 or 3, and particularly preferably 3, from the viewpoint that the surface-treated layer becomes more excellent abrasion resistance.

In Formula (3-21), X, m, R, n and L have the same definitions as X, m, R, n and L in Formula (3).

R^{f2} is perfluoroalkyl group, and preferred embodiments and specific examples of perfluoroalkyl groups are as described above.

j2 is an integer 2 or more, preferably an integer from 2 to 6, and more preferably an integer from 2 to 4.

Y²¹ is a (j2+g2)-valent linking group, and specific example thereof is the same as Z in Formula (3).

g2 is an integer 2 or more, preferably an integer from 2 to 15, more preferably an integer from 2 to 6, still more preferably from 2 to 4, and particularly preferably 4, from the viewpoint that the surface-treated layer becomes more excellent abrasion resistance.

In Formula (3-31), X, m, R, n and L have the same definitions as X, m, R, n and L in Formula (3).

k3 is an integer 1 or more, preferably an integer from 1 to 4, more preferably 2 or 3, and still more preferably 3.

Y³² is a (k3+1)-valent linking group, and specific example thereof is the same as Q in Formula (3).

Y³¹ is a (g3+1)-valent linking group, and specific example thereof is the same as Z in Formula (3).

g3 is an integer 1 or more, preferably an integer from 1 to 4, more preferably 2 or 3, and still more preferably 3.

Y¹¹ in Formula (3-11) may be Group (g2-1) (note that d1+d3=1, i.e. d1 or d3 is 0, g1=d2+d4, and d2+d4>2), Group (g2-2) (note that e1=1, g1=e2, and e2>2), Group (g2-3) (note that g1=2), Group (g2-4) (note that h1=1, g1=h2, and h2>2), Group (g2-5) (note that i1=1, g1=i2, and i2>2), Group (g2-7) (note that g1=i3+1), Group (g2-8) (note that g1=i4, and i4>2), or Group (g2-9) (note that g1=i5, and i5>2).

Y²¹ in Formula (3-21) may be Group (g2-1)(note that j2=d1+d3, d1+d3>2, g2=d2+d4, and d2+d4>2), Group (g2-2) (note that j2=e1, e1=2, g2=e2, and e2=2), Group (g2-4) (note that j2=h1, h1>2, g2=h2, and h2>2), or Group (g2-5) (note that j2=i1, i1=2, g2=i2, and i2=2).

Each of Y³¹ and Y³² in Formula (3-31) may be independently Group (g2-1) (note that g3=d2+d4, and k3=d2+d4), Group (g2-2) (note that g3=e2, and k3=e2), Group (g2-3) (note that g3=2, and k3=2), Group (g2-4) (note that g3=h2, and k3=h2), Group (g2-5) (note that g3=i2, and k3=i2), Group (g2-6) (note that g3=1, and k3=1), Group (g2-7) (note that g3=i3+1, and k3=i3+1), Group (g2-8) (note that g3=i4, and k3=i4), or Group (g2-9) (note that g3=i5, and k3=i5).

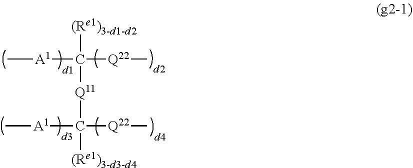

(-A¹-)ₑ₁C(R^{e2})₄₋ₑ₁₋ₑ₂(-Q²²-)ₑ₂ (g2-2)

-A¹-N(-Q²³-)₂ (g2-3)

(-A¹-)ₕ₁Z¹(-Q²⁴-)ₕ₂ (g2-4)

(-A¹-)ᵢ₁Si(R^{e3})₄₋ᵢ₁₋ᵢ₂(-Q²⁵-)ᵢ₂ (g2-5)

-A¹-Q²⁶- (g2-6)

-A¹-CH(-Q²²-)—Si(R^{e3})₃₋ᵢ₃(-Q²⁵-)ᵢ₃ (g2-7)

-A¹-[CH₂C(R^{e4})(-Q²⁷-)]ᵢ₄-R^{e5} (g2-8)

-A¹-Z^{a}(-Q²⁸-)ᵢ₅ (g2-9)

Note that in Formulae (g2-1) to (g2-9), the A¹ side connects to (OX)ₘ, and Q²², Q²³, Q²⁴, Q²⁵, Q²⁶, Q²⁷ and Q²⁸ sides connect to [—Si(R)ₙL₃₋ₙ].

A¹ is: a single bond; an alkylene group; or a group in which —C(O)NR^{6A}—, —C(O)—, —OC(O)O—, —NHC(O)O—, —NHC(O)NR^{6A}—, —O—, or —SO₂NR^{6A}— is present between carbon-carbon atoms of an alkylene group having two or more carbon atoms. In each formula, in a case in which two or more A¹s are present, two or more A¹s may be the same or different. The hydrogen atom of the alkylene group may be substituted with a fluorine atom.

Q²² is: an alkylene group; a group in which —C(O)NR^{6A}—, —C(O)—, —N^{6A}—, or —O— is present between carbon-carbon atoms of an alkylene group having two or more carbon atoms; a group in which —C(O)NR^{6A}—, —C(O)—, —NR^{6A}—, or —O— is present at one end, being not connected to Si, of an alkylene group; or a group in which —C(O)NR^{6A}—, —C(O)—, —NR^{6A}—, or —O— is present between carbon-carbon atoms of an alkylene group having two or more carbon atoms and —C(O)NR^{6A}—, —C(O)—, —NR^{6A}—, or —O— is present at an end, being not connected to Si, of the alkylene group. In each formula, in a case in which two or more Q²²s are present, two or more Q²²s may be the same or different.

Q²³ is: an alkylene group; or a group in which —C(O)NR^{6A}—, —C(O)—, —NR^{6A}—, or —O— is present between carbon-carbon atoms of an alkylene group having two or more carbon atoms. Two Q²³s may be the same or different.

In a case in which the atom in Z¹, to which Q²⁴ binds, is a carbon atom, Q²⁴ is Q²². In a case in which the atom in Z¹, to which Q²⁴ binds, is a nitrogen atom, Q²⁴ is Q²³. In each formula, in a case in which two or more Q²⁴s are present, two or more Q²⁴s may be the same or different.

Q²⁵ is: an alkylene group; or a group in which —C(O)NR^{6A}—, —C(O)—, —NR^{6A}—, or —O— is present between carbon-carbon atoms of alkylene group having two or more carbon atoms. In each formula, in a case in which two or more Q²⁵s are present, two or more Q²⁵s may be the same or different.

Q²⁶ is: an alkylene group; or a group in which —C(O)NR^{6A}—, —C(O)—, —NR^{6A}—, or —O— is present between carbon-carbon atoms of alkylene group having two or more carbon atoms.

R^{6A} is a hydrogen atom, an alkyl group having from 1 to 6 carbon atoms, or a phenyl group.

Q²⁷ is a single bond or an alkylene group.

Q²⁸ is an alkylene group or a group in which an etheric oxygen atom or a divalent organopolysiloxane residue is present between carbon-carbon atoms of alkylene group having two or more carbon atoms.

Q¹¹ is: a single bond; an alkylene group; or a group in which —C(O)NR^{6A}—, —C(O)—, —OC(O)O—, —NHC(O)O—, —NHC(O)NR^{6A}—, —O—, or —SO₂NR^{6A}— is present between carbon-carbon atoms of alkylene group having two or more carbon atoms.

Z¹ is a group that has a carbon or nitrogen atom to which A¹ directly binds and that has a (h1+h2)-valent ring structure having a carbon or nitrogen atom to which Q²⁴ directly binds.

R^{e1} is a hydrogen atom, or an alkyl group. In each formula, in a case in which two or more R^{e1}s are present, two or more R^{e1}s may be the same or different.

R^{e2} is a hydrogen atom, a hydroxy group, an alkyl group, or acyloxy group.

R^{e3} is an alkyl group.

R^{e4} is a hydrogen atom, or an alkyl group, and preferably a hydrogen atom from the viewpoint of the ease of producing a compound. In each formula, in a case in which two or more R^{e4}s are present, two or more R^{e4}s may be the same or different.

R⁵ is a hydrogen atom, or a halogen atom, and preferably a hydrogen atom from the viewpoint of the ease of producing a compound.

d1 is an integer from 0 to 3, and preferably 1 or 2. d2 is an integer from 0 to 3, and preferably 1 or 2. d1+d2 is an integer from 1 to 3.

d3 is an integer from 0 to 3, and preferably 0 or 1. d4 is an integer from 0 to 3, and preferably 2 or 3. d3+d4 is an integer from 1 to 3.

d1+d3 in Y¹ is an integer from 1 to 5, and preferably 1 or 2. d1+d3 in Y¹¹, Y³¹ or Y³² is 1.

d2+d4 in Y¹¹ or Y²¹ is an integer from 2 to 5, and preferably 4 or 5. d2+d4 in Y³¹ or Y³² is an integer from 3 to 5, and preferably 4 or 5.

e1+e2 is 3 or 4. e1 in Y¹¹ is 1. e1 in Y²¹ is an integer from 2 to 3, e1 in Y³¹ or Y³² is 1. e2 in Y¹¹ or Y²¹ is an integer from 2 to 3, e2 in Y³¹ or Y³² is 2 or 3.

h1 in Y¹¹ is 1. h1 in Y²¹ is an integer of 2 or more, and preferably 2. h1 in Y³¹ or Y³² is 1. h2 in Y¹¹ or Y²¹ is an integer of 2 or more, and preferably 2 or 3. h2 in Y³¹ or Y³² is an integer of 1 or more, and preferably 2 or 3.

i1+i2 in Y¹¹ is 3 or 4. i1+i2 in Y²¹ is 4. i1+i2 in Y³¹ or Y³² is 3 or 4. i1 in Y¹¹ is 1. i1 in Y²¹ is 2. i1 in Y³¹ or Y³² is 1. i2 in Y¹¹ is 2 or 3. i2 in Y²¹ is 2. i2 in Y³¹ or Y³² is 2 or 3.

i3 is 2 or 3.

i4 in Y¹¹ is 2 or more, preferably 2 or 10, and more preferably 2 to 6. i4 in Y³¹ or Y³² is 1 or more, preferably 1 or 10, and more preferably 1 to 6.

i5 is 2 or more, preferably an integer from 2 to 7

A number of carbon atoms of alkylene groups of Q²², Q²³, Q²⁴, Q²⁵, Q²⁶, Q²⁷, and Q²⁸ are preferably from 1 to 10, more preferably from 1 to 6, and still more preferably from 1 to 4 from the viewpoint of the ease of producing Compound (3-11), Compound (3-21), and Compound (3-31) and the viewpoint of further excellent abrasion resistance, light resistance, and chemical resistance of the surface-treated layer. Note that a lower limit of the number of carbon atoms of an alkylene group having a specific bond between carbon-carbon atoms is 2.

Examples of the ring structure for Z¹ include the ring structures described above, and preferred embodiments are also the same. Since A¹ and Q²⁴ directly bind to the ring structure for Z¹, in a case in which, for example, an alkylene group is linked to the ring structure, A¹ and Q²⁴ do not bind to the alkylene group.

Z^{a} is an (i5+1)-valent organopolysiloxane residue, and preferably the following groups. R^{a} in the following formulas is an alkyl group (preferably having from 1 to 10 carbon atoms) or a phenyl group.

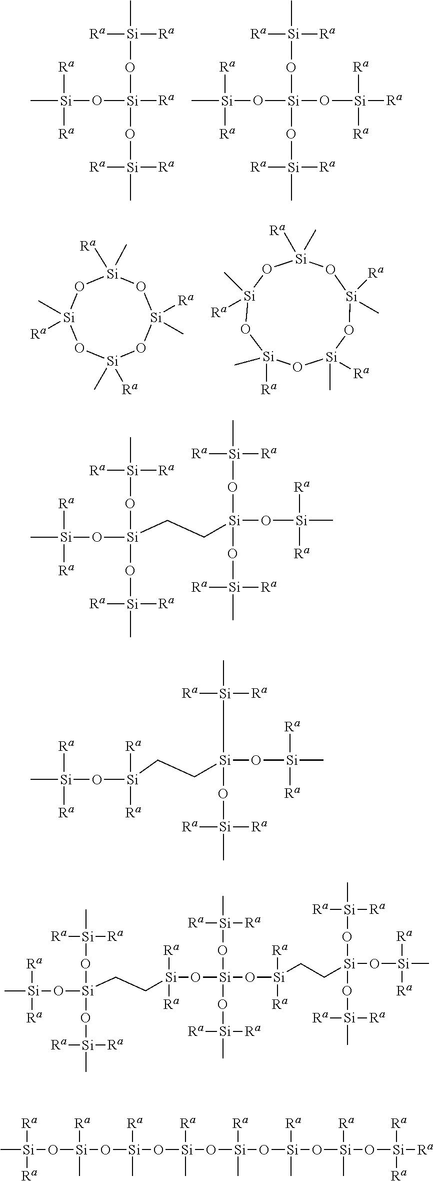

A number of carbon atoms of the alkyl group represented by R^{e1}, R^{e2}, R^{e3} or R^{e4} is preferably from 1 to 10, more preferably from 1 to 6, still more preferably from 1 to 3, and particularly preferably an integer from 1 to 2, from the viewpoint of the ease of producing Compound (3-11), Compound (3-21) and Compound (3-31).

A number of carbon atoms of an alkyl group portion in the acyloxy group represented by R^{e2} is preferably from 1 to 10, more preferably from 1 to 6, still more preferably from 1 to 3, and particularly preferably an integer from 1 to 2, from the viewpoint of the ease of producing Compound (3-11), Compound (3-21) and Compound (3-31).

h1 is preferably from 1 to 6, more preferably from 1 to 4, still more preferably 1 or 2, and particularly preferably 1, from the viewpoint of the ease of producing Compound (3-11), Compound (3-21) and Compound (3-31) and the viewpoint of excellent abrasion resistance and excellent water and oil repellency of the surface-treated layer.

h2 is preferably from 2 to 6, more preferably from 2 to 4, and still more preferably 2 or 3, from the viewpoint of the ease of producing Compound (3-11), Compound (3-21) and Compound (3-31) and the viewpoint of excellent abrasion resistance and excellent water and oil repellency of the surface-treated layer.

Examples of other embodiments of Y¹¹ include Group (g3-1) (note that d1+d3=1 (i.e. d1 or d3 is 0), and g1=d2×r1+d4×r1), Group (g3-2) (note that e1=1, and g1=e2×r1), Group (g3-3) (note that g1=2×r1), Group (g3-4) (note that h1=1, and g1=h2×r1), Group (g3-5) (note that i1=1, and g1=i2×r1), Group (g3-6) (note that g1=r1), Group (g3-7) (note that g1=r1×(i3+1)), Group (g3-8) (note that g1=r1×i4), group(g3-9) (note that g1=r1×i5).

Examples of other embodiments of Y²¹ include Group (g3-1) (note that j2=d1+d3, d1+d3≥2, and g2=d2×r1+d4×r1), Group (g3-2) (note that j2=e1, e1=2, g2=e2×r1, and e2=2), Group (g3-4) (note that j2=h1, h1≥2, g2=h2×r1), Group (g3-5) (note that j2=i1, i1 is 2 or 3, g2=i2×r1, and i1+i2 is 3 or 4).

Examples of other embodiments of Y³¹ and Y³² include Group (g3-1) (note that g3=d2×r1+d4×r1, and k3=d2×r1+d4×r1), Group (g3-2) (note that g3=e2×r1, and k3=e2×r1), Group (g3-3) (note that g3=2×r1, and k3=2×r1), Group (g3-4) (note that g3=h2×r1, and k3=h2×r1), Group (g3-5) (note that g3=i2×r1, and k3=i2×r1), Group (g3-6) (note that g3=r1, and k3=r1), Group (g3-7) (note that g3=r1×(i3+1), and k3=r1×(i3+1)), Group (g3-8) (note that g3=r1×i4, and k3=r1×i4), Group (g3-9) (note that g3=r1×i5, and k3=r1×i5).

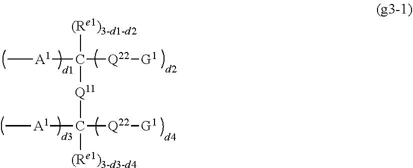

(-A¹-)ₑ₁C(R^{e2})₄₋ₑ₁₋ₑ₂(-Q²²-G¹)ₑ₂ (g2-2)

-A¹-N(-Q²³-G¹)₂ (g2-3)

(-A¹-)ₕ₁Z¹(-Q²⁴-G¹)ₕ₂ (g2-4)

(-A¹-)ᵢ₁Si(R^{e3})₄₋ᵢ₁₋ᵢ₂(-Q²⁵-G¹)ᵢ₂ (g2-5)

-A¹-Q²⁶-G¹ (g2-6)

-A¹-CH(-Q²²-G¹)—Si(R^{e3})₃₋ᵢ₃(-Q²⁵-G¹)ᵢ₃ (g2-7)

-A¹-[CH₂C(R^{e4})(-Q²⁷-G¹)]ᵢ₄-R^{e5} (g2-8)

-A¹-Z^{a}(-Q²⁸-G¹)ᵢ₅ (g2-9)

Note that in Formulae (g3-1) to (g3-9), the A¹ side connects to (OX)ₘ, and G¹ side connect to [—Si(R)ₙL₃₋ₙ].

G¹ is a Group (g3). In a case in which in a case in which two or more G¹s are present in each formula, two or more G¹s may be the same or different. Reference symbols other than G¹ are the same as those in Formulas (g2-1) to (g2-9).

—Si(R^{8A})₃₋ᵣ₁(-Q³-)ᵣ₁ (g3)

In Formula (g3), the Si side is connected to Q²², Q²³, Q²⁴, Q²⁵, Q²⁶, Q²⁷, and Q²⁸, and the Q³ side is connected to [—Si(R)ₙL₃₋ₙ]. R^{8A} is an alkyl group. Q³ is: —O—; an alkylene group; a group in which —C(O)NR^{6A}—, —C(O)—, —NR^{6A}—, or —O— is present between carbon-carbon atoms of an alkylene group having two or more carbon atoms; or —(OSi(R^{9A})₂)ₚ—O—. Two or more Q³s may be the same or different. r1 is 2 or 3. R^{6A} is a hydrogen atom, an alkyl group having from 1 to 6 carbon atoms, or a phenyl group. R^{9A} is an alkyl group, a phenyl group, or an alkoxy group. Two or more R^{9A}s may be the same or different. p is an integer from 0 to 5. In a case in which p is 2 or more, two or more of (OSi(R^{9A})₂) may be the same or different.

A number of carbon atoms of the alkylene group represented by Q³ is preferably from 1 to 10, more preferably from 1 to 6, and still more preferably from 1 to 4, from the viewpoint of the ease of producing Compound (3-11), Compound (3-21) and Compound (3-31) and the viewpoint of further excellent abrasion resistance, light resistance, and chemical resistance of the surface-treated layer. Note that a lower limit of the number of carbon atoms of an alkylene group having a specific bond between carbon-carbon atoms is 2.

A number of carbon atoms of the alkyl group represented by R^{8A} is preferably from 1 to 10, more preferably from 1 to 6, still more preferably from 1 to 3, and particularly preferably 1 to 2, from the viewpoint of the ease of producing Compound (3-11), Compound (3-21) and Compound (3-31).

A number of carbon atoms of the alkyl group represented by R^{9A} is preferably from 1 to 10, more preferably from 1 to 6, still more preferably from 1 to 3, and particularly preferably 1 to 2, from the viewpoint of the ease of producing Compound (3-11), Compound (3-21) and Compound (3-31).

A number of carbon atoms of the alkoxy group represented by R^{9A} is preferably from 1 to 10, more preferably from 1 to 6, still more preferably from 1 to 3, and particularly preferably 1 to 2, from the viewpoint of the ease of producing Compound (3-11), Compound (3-21) and Compound (3-31). p is preferably 0 or 1.

Examples of Compound (3-11), Compound (3-21) and Compound (3-31) include a compound of the following formula and a compound in which at least portion of the methoxy groups bonded to silicon atoms contained in the following compound are substituted with an ethoxy group. The compound of the following formula is preferable because it is industrially easy to produce and handle and is excellent in water and oil repellency, abrasion resistance, lubricity, light resistance, and chemical resistance of the surface-treated layer, particularly in light resistance. R^{f} in a compound of the following formula is the same as R^{f1}—(OX)ₘ—O— in Formula (3-11) described above or R^{f2}—(OX)ₘ—O— in Formula (3-21) described above, and preferred aspects are also the same. Q^{f} in a compound of the following formula is the same as —(OX)ₘ—O— in Formula (3-31), and preferred aspects are also the same. In a case in which there is a stereoisomer of a compound of the following formula, the compound may be any stereoisomer or a mixture of stereoisomers.

Examples of Compound (3-11) in which Y¹¹ is Group (g2-1) include compounds of the following formulae.

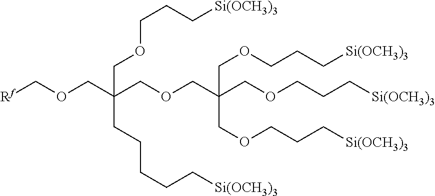

Examples of Compound (3-11) in which Y¹¹ is Group (g2-2) include compounds of the following formulae.

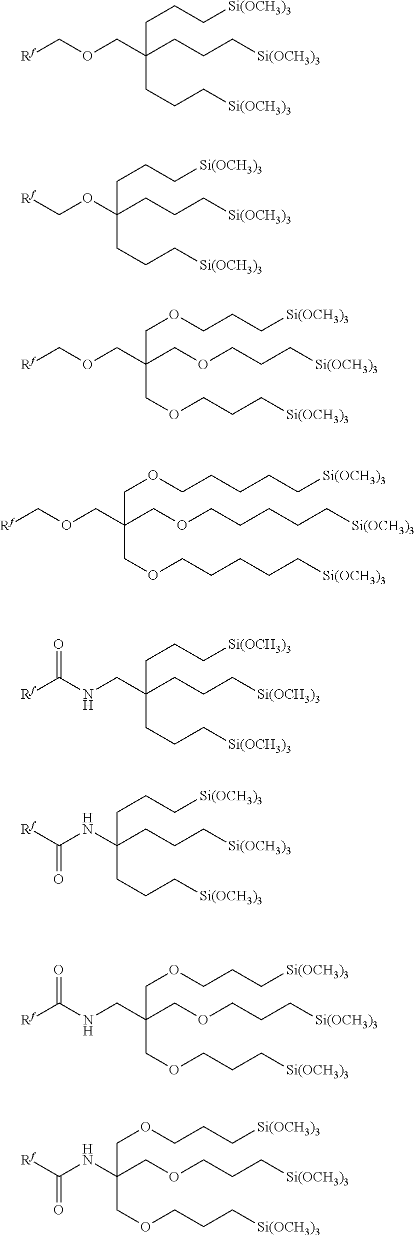

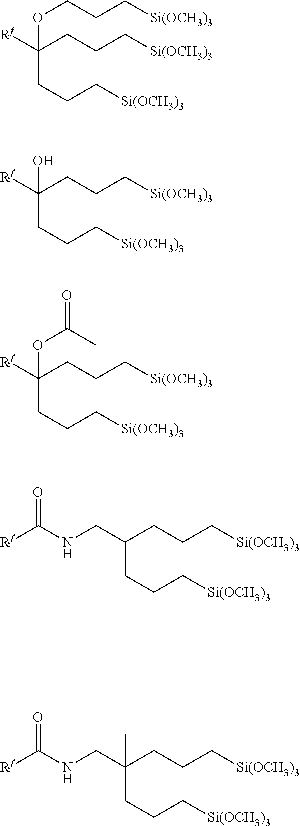

Examples of Compound (3-21) in which Y²¹ is Group (g2-2) include compounds of the following formulae.

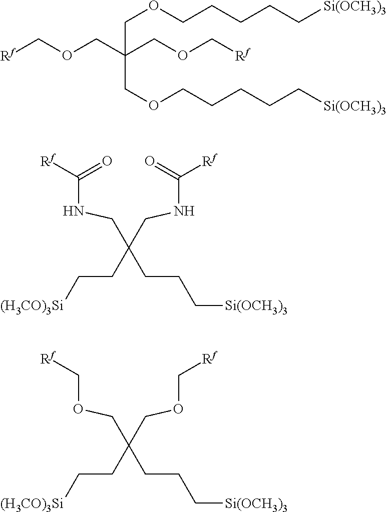

Examples of Compound (3-11) in which Y¹¹ is Group (g2-4) include compounds of the following formulae.

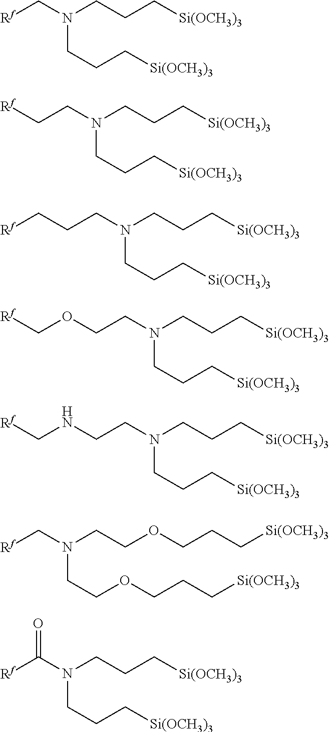

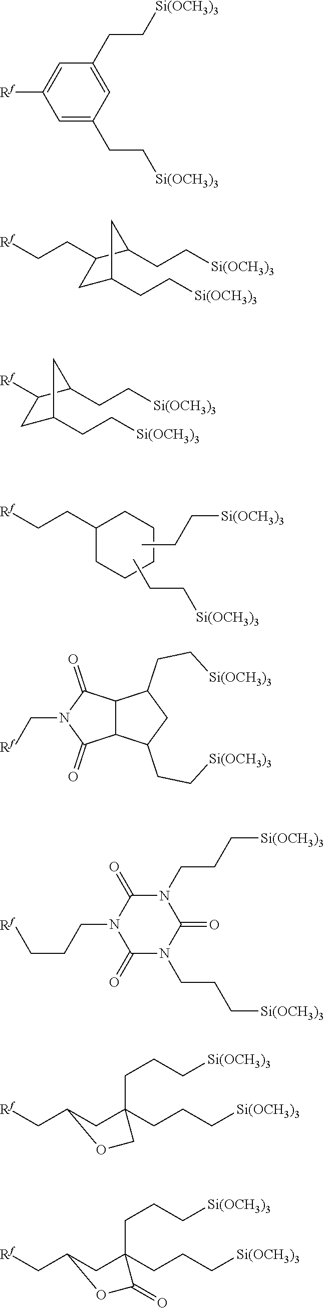

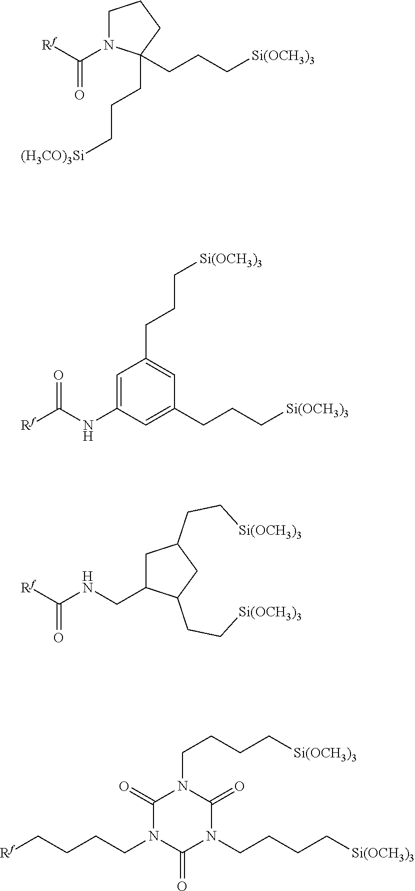

Examples of Compound (3-11) in which Y¹¹ is Group (g2-5) include compounds of the following formulae.

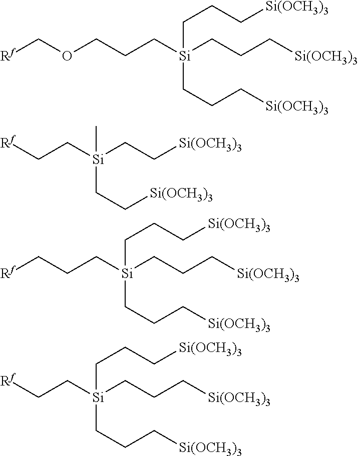

Examples of Compound (3-11) in which Y¹¹ is Group (g2-7) include compounds of the following formulae.

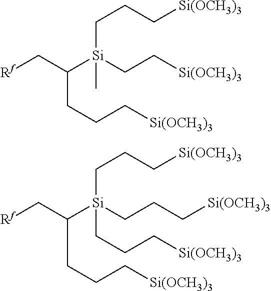

Examples of Compound (3-11) in which Y¹¹ is Group (g3-1) include compounds of the following formulae.

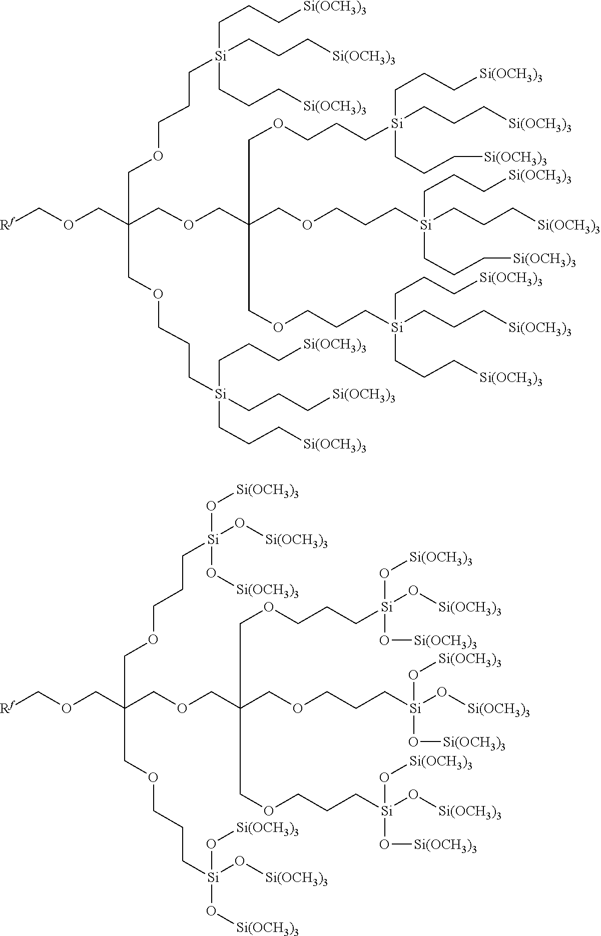

Examples of Compound (3-11) in which Y¹¹ is Group (g3-2) include compounds of the following formulae.

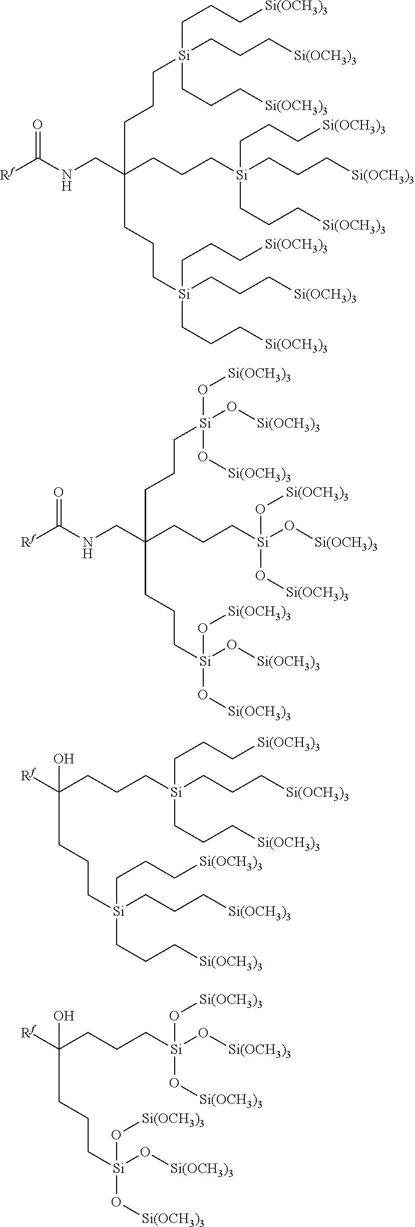

Examples of Compound (3-11) in which Y¹¹ is Group (g3-3) include compounds of the following formulae.

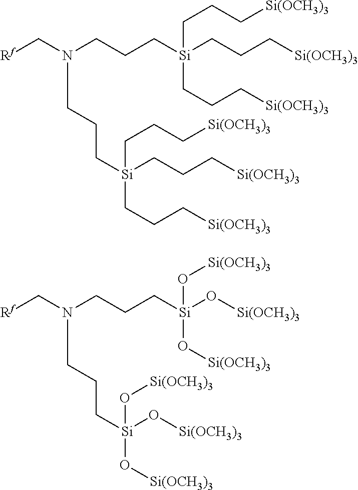

Examples of Compound (3-11) in which Y¹¹ is Group (g3-4) include compounds of the following formulae.

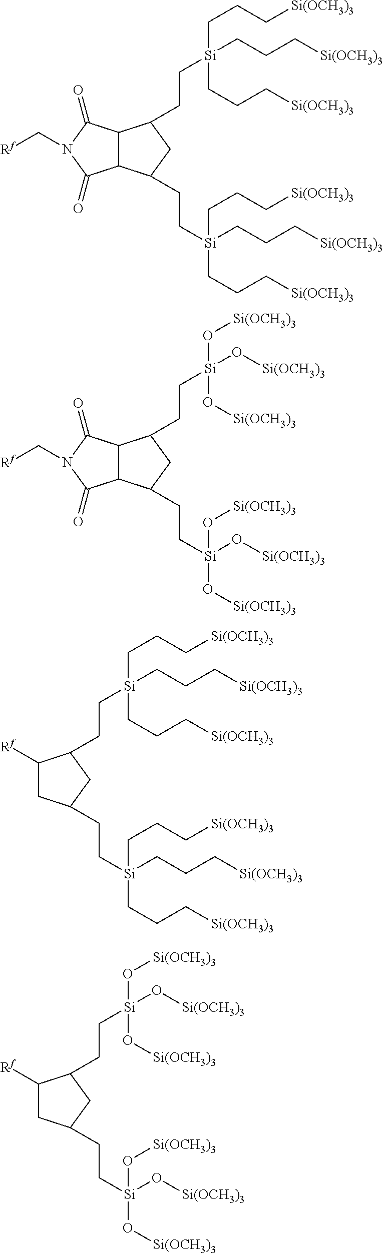

Examples of Compound (3-11) in which Y¹¹ is Group (g3-5) include compounds of the following formulae.

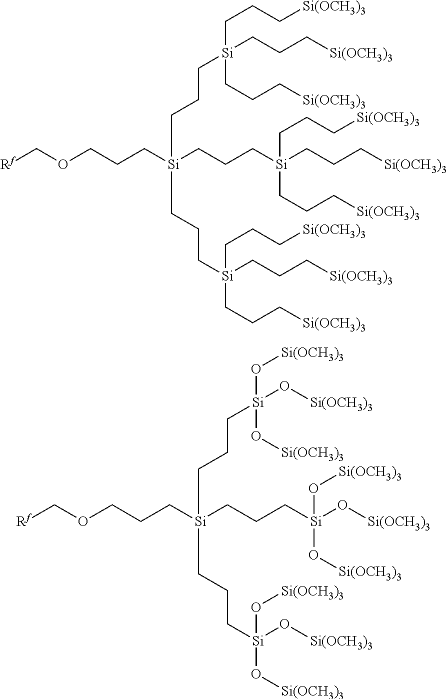

Examples of Compound (3-11) in which Y¹¹ is Group (g3-6) include compounds of the following formulae.

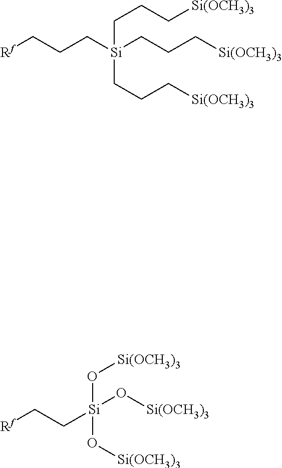

Examples of Compound (3-11) in which Y¹¹ is Group (g3-7) include compounds of the following formulae.

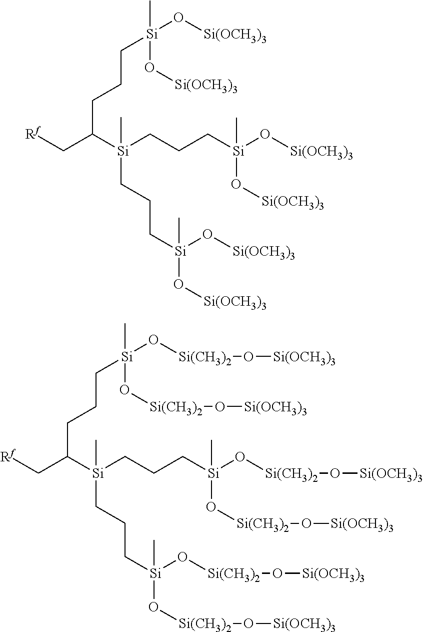

Examples of Compound (3-21) in which Y²¹ is Group (g2-1) include compounds of the following formulae.

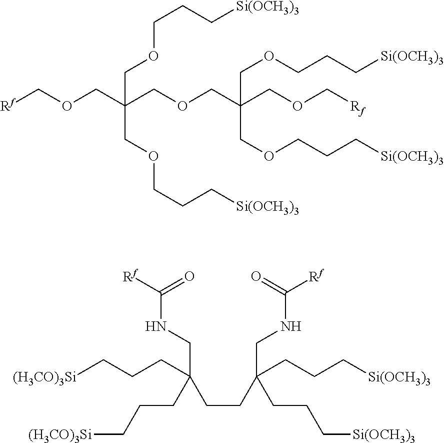

Examples of Compound (3-31) in which Y³¹ and Y³² are Group (g2-1) include compound of the following formula.

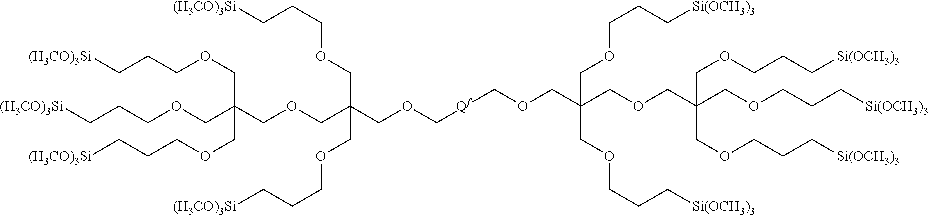

Examples of Compound (3-31) in which Y³¹ and Y³² are Group (g2-2) include compounds of the following formulae.

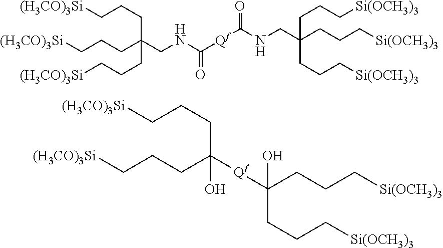

Examples of Compound (3-31) in which Y³¹ and Y³² are Group (g2-3) include compound of the following formula.

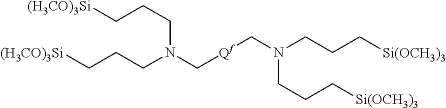

Examples of Compound (3-31) in which Y³¹ and Y³² are Group (g2-4) include compound of the following formula.

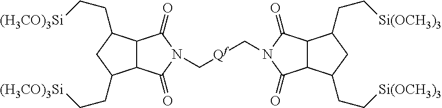

Examples of Compound (3-31) in which Y³¹ and Y³² are Group (g2-5) include compound of the following formula.

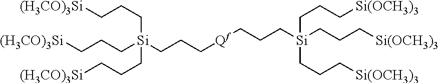

Examples of Compound (3-31) in which Y³¹ and Y³² are Group (g2-6) include compound of the following formula.

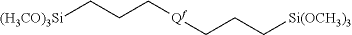

Examples of Compound (3-31) in which Y³¹ and Y³² are Group (g2-7) include compound of the following formula.

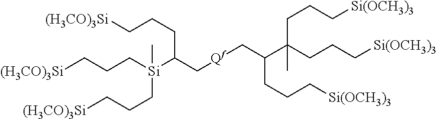

Examples of Compound (3-31) in which Y³¹ and Y³² are Group (g3-2) include compounds of the following formulae.

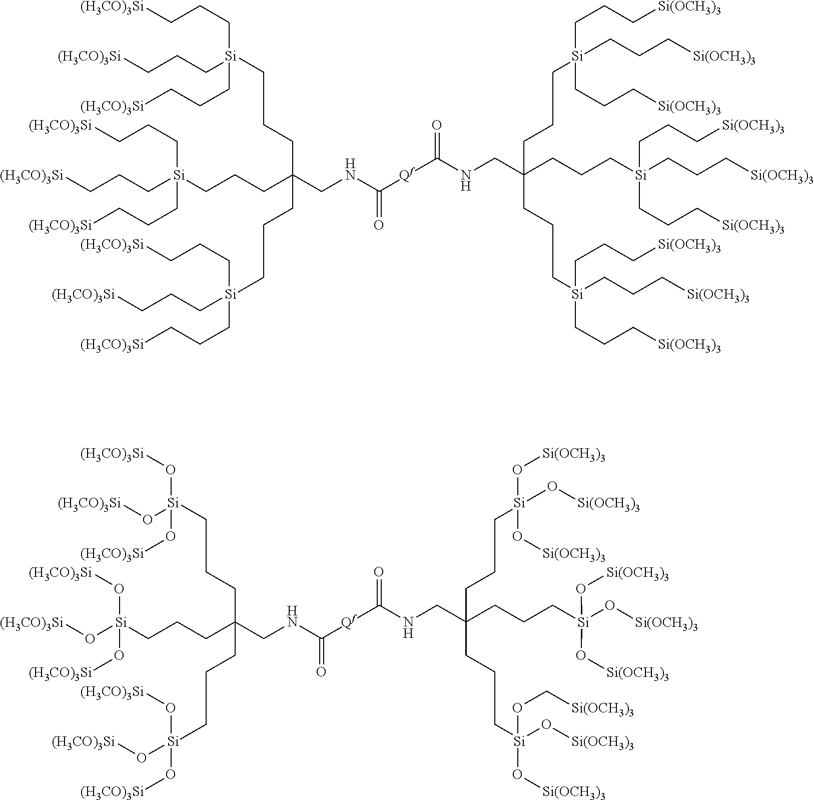

Compound (A) is also preferably a compound represented by Formula (3X), from the viewpoint that the membrane has more excellent water and oil repellency and abrasion resistance.

[A-(OX)ₘ]ⱼZ′[—Si(R)ₙL₃₋ₙ]_{g} (3X)

In Formula (3X), A, X, m, j, g, R, L and n have the same definitions as each groups in Formula (3).

Compound (3X) is also preferably a compound represented by Formula (3-1), from the viewpoint that the surface-treated layer has more excellent water and oil repellency and abrasion resistance.

A-(OX)ₘ—Z³¹ (3-1)

In Formula (3-1), A, X and m have the same definitions as each groups in Formula (3).

Z′ is a (j+g)-valent linking group.

Z′ is not limited as long as it does not impair the abrasion resistance of the surface-treated layer, for example, includes an alkylene group that may have an etheric oxygen atom or a divalent organopolysiloxane residue, an oxygen atom, a carbon atom, a nitrogen atom, a silicon atom, a divalent to octavalent organopolysiloxane residue, and groups resulting from excluding Si(R)ₙL₃₋ₙ from Formulas (3-1A), (3-1B), or Formulas (3-1A-1) to (3-1A-6).

Z³¹ is group (3-1A) or group (3-1B).

-Q^{a}-X³¹(-Q^{b}-Si(R)ₙL₃₋ₙ)ₕ(—R³¹)ᵢ (3-1A)

-Q^{c}-[CH₂C(R³²)(-Q^{d}-Si(R)ₙL₃₋ₙ)]_{y}—R³³ (3-1B)

The definitions of R, n and L in Formulas (3-1A) and (3-1B) are the same as those of R, n and L in Formula (3), respectively.

Q^{a} is a single bond or a divalent linking group.

Examples of a divalent linking group include a divalent hydrocarbon group, a divalent heterocyclic group, —O—, —S—, —SO₂—, —N(R^{d})—, —C(O)—, —Si(R^{a})₂—, and any combination of two or more of these. Ra is an alkyl group (preferably having from 1 to 10 carbon atoms) or a phenyl group. R^{d} is a hydrogen atom or an alkyl group (preferably having from 1 to 10 carbon atoms).

Examples of the divalent hydrocarbon group include a divalent saturated hydrocarbon group, a divalent aromatic hydrocarbon group, an alkenylene group, and an alkynylene group. The divalent saturated hydrocarbon group may be linear, branched, or cyclic. Examples of the divalent saturated hydrocarbon group include an alkylene group. A number of carbon atoms of the divalent saturated hydrocarbon group is preferably from 1 to 20. A number of carbon atoms of the divalent aromatic hydrocarbon group is preferably from 5 to 20. Examples of the divalent aromatic hydrocarbon group include a phenylene group. The alkenylene group is preferably an alkenylene group having from 2 to 20 carbon atoms. The alkynylene group is preferably an alkynylene group having from 2 to 20 carbon atoms.

Examples of a combination of two or more of the groups described above include —OC(O)—, —C(O)N(R^{d})—, an alkylene group having an etheric oxygen atom, an alkylene group having —OC(O)—, and alkylene group —Si(R^{a})₂-phenylene group-Si(R^{a})₂—.

X³¹ is a single bond, an alkylene group, a carbon atom, a nitrogen atom, a silicon atom, or a divalent to octavalent organopolysiloxane residue.

The alkylene group may have —O—, a silphenylene structure group, a divalent organopolysiloxane residue, or a dialkyl silylene group. The alkylene group may have a plural groups selected from the group consisting of —O—, a silphenylene structure group, divalent organopolysiloxane residue, and a dialkyl silylene group.

A number of carbon atoms of an alkylene group represented by X³¹ is preferably from 1 to 20, and more preferably from 1 to 10.

Examples of the divalent to octavalent organopolysiloxane residue include a divalent organopolysiloxane residue and the above-described (i5+1)-valent organopolysiloxane residue.

Q^{b} is a single bond or a divalent linking group.

The definition of a divalent linking group has the same meaning as the definition described for Q^{a} above.

R³¹ is a hydroxyl group or an alkyl group.

A number of carbon atoms of an alkyl group is preferably from 1 to 5, more preferably from 1 to 3, and still more preferably 1.

In a case in which X³¹ is a single bond or an alkylene group, h is 1, and i is 0.

In a case in which X³¹ is a nitrogen atom, h is an integer from 1 to 2, i is an integer from 0 to 1, and h+i=2 is satisfied.

In a case in which X³¹ is a carbon atom or a silicon atom, h is an integer from 1 to 3, i is an integer from 0 to 2, and h+i=3 is satisfied.

In a case in which X³¹ is a divalent to octavalent organopolysiloxane residue, h is an integer from 1 to 7, i is an integer from 0 to 6, and h+i=1 to 7 is satisfied.

In a case in which there are two or more of (-Q^{b}-Si(R)ₙL₃₋ₙ), two or more of (-Q^{b}-Si(R)ₙL₃₋ₙ) may be the same or different. In a case in which there are two or more R31s, two or more of (—R³¹) may be the same or different.

Q^{c} is a single bond or an alkylene group that may have an etheric oxygen atom. Q^{c} is preferably a single bond from the viewpoint of the ease of producing a compound.

A number of carbon atoms of the alkylene group that may have an etheric oxygen atom is preferably from 1 to 10, and more preferably from 2 to 6.

R³² is a hydrogen atom or an alkyl group having from 1 to 10 carbon atoms, and preferably a hydrogen atom from the viewpoint of the ease of producing a compound.

The alkyl group is preferably methyl group.

Q^{d} is a single bond or an alkylene group. A number of carbon atoms of the alkylene group is preferably from 1 to 10, and more preferably from 1 to 6. Q^{d} is preferably a single bond or —CH₂— from the viewpoint of the ease of producing a compound.

R³³ is a hydrogen atom or a halogen atom, and preferably a hydrogen atom from the viewpoint of the ease of producing a compound.

y is an integer from 1 to 10, and preferably an integer 1 to 6.

Two or more of [CH₂C(R³²)(-Q^{d}-Si(R)ₙL₃₋ₙ)] may be the same or different.

Group (3-1A) is preferably groups (3-1A-1) to (3-1A-6).

—(X³²)ₛ₁-Q^{b1}-Si(R)ₙL₃₋ₙ (3-1A-1)

—(X³³)ₛ₂-Q^{a2}-N[-Q^{b2}-Si(R)ₙL₃₋ₙ]₂ (3-1A-2)

-Q^{a3}-G(R^{g})[-Q^{b3}-Si(R)ₙL₃₋ₙ]₂ (3-1A-3)

—[C(O)N(R^{d})]ₛ₄-Q^{a4}-(O)ₜ₄—C[—(O)ᵤ₄-Q^{b4}-Si(R)ₙL₃₋ₙ]₃ (3-1A-4)

-Q^{a5}-Si[-Q^{b5}-Si(R)ₙL₃₋ₙ]₃ (3-1A-5)

—[C(O)N(R^{d})]ᵥ-Q^{a6}-Z^{a′}[-Q^{b6}-Si(R)ₙL₃₋ₙ]_{w} (3-1A-6)

The definition of R, L and n in Formula (3-1A-1) to (3-1A-6) is as described above.

X³² is —O—, or —C(O)N(R^{d})—, in which N in the formula connects to Q^{b1}.

The definition of R^{d} is as described above.

s1 is 0 or 1.

Q^{b1} is an alkylene group. The alkylene group may have —O—, a silphenylene structure group, a divalent organopolysiloxane residue, or a dialkyl silylene group. The alkylene group may have plural groups selected from the group consisting of —O—, a silphenylene structure group, a divalent organopolysiloxane residue, and a dialkyl silylene group.

In a case in which the alkylene group has —O—, a silphenylene structure group, a divalent organopolysiloxane residue, or a dialkyl silylene group, it is preferable that the alkylene group has these groups between carbon-carbon atoms.

A number of carbon atoms of an alkylene group represented by Q^{b1} is preferably from 1 to 10, and more preferably from 2 to 6.

In a case in which s1 is 0, Q^{b1} is preferably —CH₂OCH₂CH₂CH₂—, —CH₂OCH₂CH₂OCH₂CH₂CH₂—, —CH₂CH₂—, —CH₂CH₂CH₂—, or —CH₂OCH₂CH₂CH₂Si(CH₃)₂OSi(CH₃)₂CH₂CH₂—. In a case in which (X³²)ₛ₁ is —O—, Q^{b1} is preferably —CH₂CH₂CH₂—, -or CH₂CH₂OCH₂CH₂CH₂. In a case in which (X³²)ₛ₁ is —C(O)N(R^{d})—, Q^{b1} is preferably an alkylene group having from 2 to 6 carbon atoms, in which N in the formula connects to Q^{b1}. In a case in which Q^{b1} is one of these groups, the compound is easy to produce.

Example of Group (3-1A-1) include the following groups and groups in which at least a portion of methoxy groups bonded to silicon atoms contained in the following groups are substituted with ethoxy group(s). In the following formula, “*” represents a binding position with (OX)ₘ.

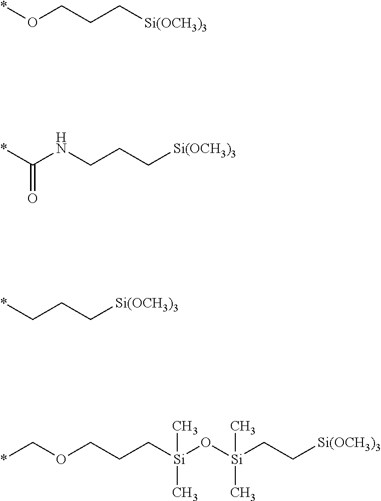

X³³ is —O—, —NH— or —C(O)N(R^{d})—.

The definition of R^{d} is as described above.

Q^{a2} is a single bond, an alkylene group, —C(O)—, or a group in which an etheric oxygen atom, —C(O)—, —C(O)O—, —OC(O)— or —NH— is present between carbon-carbon atoms of alkylene group having two or more carbon atoms.

A number of carbon atoms of an alkylene group represented by Q^{a2} is preferably from 1 to 10, and more preferably from 1 to 6.

A number of carbon atoms of a group, in which an etheric oxygen atom, —C(O)—, —C(O)O—, —OC(O)— or —NH— is present between carbon-carbon atoms of alkylene group having two or more carbon atoms, represented by Q^{a2} is preferably from 2 to 10, and more preferably from 2 to 6.

Q^{a2} is preferably —CH₂—, —CH₂CH₂—, —CH₂CH₂CH₂—, —CH₂OCH₂CH₂—, —CH₂NHCH₂CH₂—, —CH₂CH₂OC(O)CH₂CH₂—, or —C(O)—, in which the right side connects to N, from the viewpoint of the ease of producing a compound.

s2 is 0 or 1 (in a case in which Q² is a single bond, s2 is 0), and preferably 0 from the viewpoint of the ease of producing a compound.

Q^{b2} is an alkylene group, or a group in which a divalent organopolysiloxane residue, an etheric oxygen atom or —NH— is present between carbon-carbon atoms of alkylene group having two or more carbon atoms.

A number of carbon atoms of an alkylene group represented by Q^{b2} is preferably from 1 to 10, and more preferably from 2 to 6.

A number of carbon atoms of a group, in which a divalent organopolysiloxane residue, an etheric oxygen atom or —NH— is present between carbon-carbon atoms of alkylene group having two or more carbon atoms, represented by Q^{b2} is preferably from 2 to 10, and more preferably from 2 to 6.

Q^{b2} is preferably —CH₂CH₂CH₂— or —CH₂CH₂OCH₂CH₂CH₂—, in which the right side connects to Si, from the viewpoint of the ease of producing a compound.

Two or more of [-Q^{b2}-Si(R)ₙL₃₋ₙ] may be the same or different.

Examples of Group (3-1A-2) include the following groups and groups in which at least a portion of methoxy groups bonded to silicon atoms contained in the following groups are substituted with ethoxy group(s). In the following formula, “*” represents a binding position with (OX)ₘ.

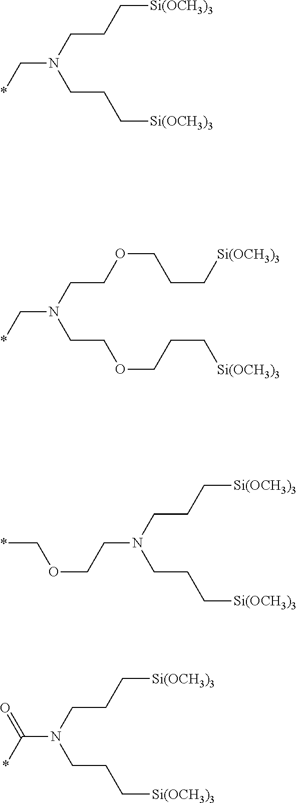

Q^{a} is a single bond or an alkylene group that may have an etheric oxygen atom. Q^{a3} is preferably a single bond from the viewpoint of the ease of producing a compound.

A number of carbon atoms of the alkylene group that may have an etheric oxygen atom is preferably from 1 to 10, and more preferably from 2 to 6.

G is carbon atom or silicon atom.

R^{g} is a hydrogen group or an alkyl group. A number of carbon atoms of the alkyl group represented by R^{g} is preferably from 1 to 4.

G(R^{g}) is preferably C(OH) or Si(R^{ga}), in which R^{ga} is alkyl group, a number of carbon atoms of the alkyl group is preferably from 1 to 10, and R^{ga} is preferably methyl, from the viewpoint of the ease of producing a compound.

Q^{b3} is an alkylene group or a group in which an etheric oxygen atom or a divalent organopolysiloxane residue is present between carbon-carbon atoms of alkylene group having two or more carbon atoms.

A number of carbon atoms of the alkylene group represented by Q^{b3} is preferably from 1 to 10, and more preferably from 2 to 6.

A number of carbon atoms of a group, in which an etheric oxygen atom or a divalent organopolysiloxane residue is present between carbon-carbon atoms of alkylene group having two or more carbon atoms, represented by Q^{b3} is preferably from 2 to 10, and more preferably from 2 to 6.

Q^{b3} is preferably —CH₂CH₂—, —CH₂CH₂CH₂— or —CH₂CH₂CH₂CH₂CH₂CH₂CH₂CH₂— from the viewpoint of the ease of producing a compound.

Two or more of [-Q^{b3}-Si(R)ₙL₃₋ₙ] may be the same or different.

Examples of Group (3-1A-3) include the following groups and groups in which at least a portion of methoxy groups bonded to silicon atoms contained in the following groups are substituted with ethoxy group(s). In the following formula, “*” represents a binding position with (OX)ₘ.

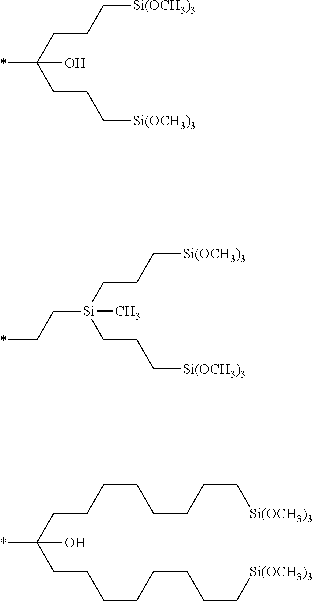

The definition of R^{d} in Formula (3-1A-4) is as described above.

s4 is 0 or 1.

Q^{a4} is a single bond or an alkylene group that may have an etheric oxygen atom.

A number of carbon atoms of the alkylene group that may have an etheric oxygen atom is preferably from 1 to 10, and more preferably from 2 to 6.

t4 is 0 or 1 (note that t4 is 0 in a case in which Q^{a4} is a single bond).

In a case in which s4 is 0, it is preferable that -Q^{a4}-(O)ₜ₄— is a single bond, —CH₂O—, —CH₂OCH₂—, —CH₂OCH₂CH₂O—, —CH₂OCH₂CH₂OCH₂—, or -CH₂OCH₂CH₂CH₂CH₂OCH₂— (note that the left side connects to (OX)ₘ) from the viewpoint of the ease of producing a compound. In a case in which s4 is 1, single bond, —CH₂—, or —CH₂CH₂— is preferable.

Q^{b4} is an alkylene group. The alkylene group may have —O—, —C(O)N(R^{d})— (R^{d} is defined as above), a silphenylene structure group, a divalent organopolysiloxane residue, or a dialkyl silylene group.

In a case in which the alkylene group has —O— or a silphenylene structure group, it is preferable that the alkylene group has —O— or a silphenylene structure group between carbon-carbon atoms. In a case in which the alkylene group has —C(O)N(R^{d})—, a dialkyl silylene group, or a divalent organopolysiloxane residue, it is preferable that the alkylene group has these groups between carbon-carbon atoms or at an end that binds to (O)ᵤ₄.

A number of carbon atoms of an alkylene group represented by Q^{b4} is preferably from 1 to 10, and more preferably from 2 to 6.

u4 is 0 or 1. —(O)ᵤ₄-Q^{b4}- is preferably —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂—, —CH₂CH₂CH₂Si(CH₃)₂PhSi(CH₃)₂CH₂CH₂—, in which the right side connects to Si, from the viewpoint of the ease of producing a compound.

Three of [—(O)ᵤ₄-Q^{b4}-Si(R)ₙL₃₋ₙ] may be the same or different.

Examples of Group (3-1A-4) include the following groups and groups in which at least a portion of methoxy groups bonded to silicon atoms contained in the following groups are substituted with ethoxy group(s). In the following formula, “*” represents a binding position with (OX)ₘ.

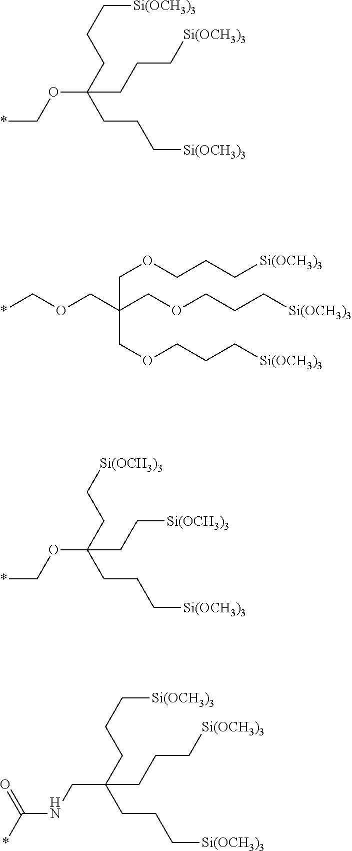

Q^{a5} is an alkylene group that may have an etheric oxygen atom.

A number of carbon atoms of the alkylene group that may have an etheric oxygen atom is preferably from 1 to 10, and more preferably from 2 to 6.

Q^{a5} is preferably —CH₂OCH₂CH₂CH₂—, —CH₂OCH₂CH₂OCH₂CH₂CH₂—, —CH₂CH₂—, —CH₂CH₂CH₂—, in which the right side connects to Si, from the viewpoint of the ease of producing a compound.

Q^{b5} is an alkylene group or a group in which an etheric oxygen atom or a divalent organopolysiloxane residue is present between carbon-carbon atoms of alkylene group having two or more carbon atoms.

A number of carbon atoms of the alkylene group represented by Q^{b5} is preferably from 1 to 10, and more preferably from 2 to 6.

A number of carbon atoms of a group, in which an etheric oxygen atom or a divalent organopolysiloxane residue is present between carbon-carbon atoms of alkylene group having two or more carbon atoms, represented by Q^{b5} is preferably from 2 to 10, and more preferably from 2 to 6.

Q^{b5} is preferably —CH₂CH₂CH₂— or —CH₂CH₂OCH₂CH₂CH₂—, in which the right side connects to Si(R)ₙL₃₋ₙ, from the viewpoint of the ease of producing a compound.

Three of [-Q^{b5}-Si(R)ₙL₃₋ₙ] may be the same or different.

Examples of Group (3-1A-5) include the following groups and groups in which at least a portion of methoxy groups bonded to silicon atoms contained in the following groups are substituted with ethoxy group(s). In the following formula, “*” represents a binding position with (OX)ₘ.

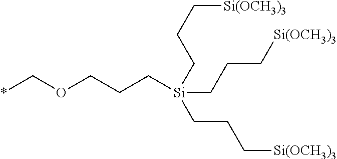

The definition of R^{d} in Formula (3-1A-6) is as described above.

v is 0 or 1.

Q^{a6} is an alkylene group that may have an etheric oxygen atom.

A number of carbon atoms of the alkylene group that may have an etheric oxygen atom is preferably from 1 to 10, and more preferably from 2 to 6.

Q^{a6} is preferably —CH₂OCH₂CH₂CH₂—, —CH₂OCH₂CH₂OCH₂CH₂CH₂—, —CH₂CH₂—, —CH₂CH₂CH₂—, in which the right side connects to Z^{a′}, from the viewpoint of the ease of producing a compound.

Z^{a′} is an (w+1)-valent organopolysiloxane residue.

w is 2 or more, and preferably an integer from 2 to 7.

Examples of (w+1)-valent organopolysiloxane residue include the same groups as the (i5+1)-valent organopolysiloxane residue described above.

Q^{b6} is an alkylene group or a group in which an etheric oxygen atom or a divalent organopolysiloxane residue is present between carbon-carbon atoms of alkylene group having two or more carbon atoms.

A number of carbon atoms of the alkylene group represented by Q^{b6} is preferably from 1 to 10, and more preferably from 2 to 6.

A number of carbon atoms of a group, in which an etheric oxygen atom or a divalent organopolysiloxane residue is present between carbon-carbon atoms of alkylene group having two or more carbon atoms, represented by Q^{b6} is preferably from 2 to 10, and more preferably from 2 to 6.

Q^{b6} is preferably —CH₂CH₂— or —CH₂CH₂CH₂— from the viewpoint of the ease of producing a compound.

Plural [-Q^{b6}-Si(R)ₙL₃₋ₙ] may be the same or different.

As Compound (3X), a compound represented by Formula (3-2) is also preferable because the water and oil repellency of the surface-treated layer is more excellent.

[A-(OX)ₘ-Q^{a}-]ⱼ₃₂Z³²[-Q^{b}-Si(R)ₙL₃₋ₙ]ₕ₃₂ (3-2)

In Formula (3-2), A, X, m, Q^{a}, Q^{b}, R and L have the same definitions as each groups in Formula (3-1) and Formula (3-1A).

Z³² is a (j32+h32)-valent hydrocarbon group; or a (j32+h32)-valent hydrocarbon group having two or more carbon atoms, in which one or more etheric oxygen atoms are present between carbon-carbon atoms of a hydrocarbon group.

Z³² is preferably a residue resulting from removing a hydroxyl group from a polyhydric alcohol having a primary hydroxyl group.

Z³² is preferably each of groups represented by Formulas (Z-1) to (Z-5) from the viewpoint of availability of raw materials. Note that R³⁴ is an alkyl group, and preferably a methyl group or an ethyl group.

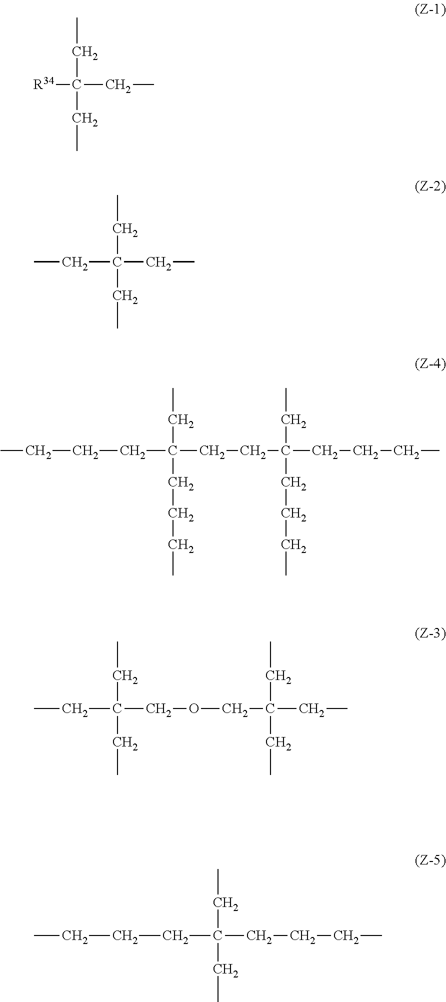

j32 is an integer of 2 or more, and preferably an integer from 2 to 5 from the viewpoint that the surface-treated layer has more excellent water and oil repellency of.

h32 is an integer of 1 or more, and preferably an integer from 2 to 4, and more preferably 2 or 3, from the viewpoint that the surface-treated layer has more excellent abrasion resistance

A number average molecular weight of compound (A) is preferably 1,000 to 20,000, more preferably 2,000 to 10,000, and still more preferably 2,500 to 6,000.

Specific examples of compound (A) include those described in the following documents.
perfluoropolyether-modified aminosilanes described in Japanese Patent Application Laid-Open (JP-A) No. 11-029585 and JP-A2000-327772,
silicon-containing organic fluorine-containing polymers described in Japanese Patent No. 2874715,
organosilicon compounds described in JP-A No. 2000-144097,
fluorinated siloxanes described in Publication of Japanese Translation of PCT International Application (JP-T) No. 2002-506887,
organic silicone compounds described in JP-T No. 2008-534696,
fluorinated modified hydrogen-containing polymers described in Japanese Patent No. 4138936,
compounds described in US Patent Application Publication No. 2010/0129672, WO 2014/126064, and JP-A No. 2014-070163,
organosilicon compounds described in WO 2011/060047 and WO 2011/059430,
fluorine-containing organosilane compounds described in WO 2012/064649,
fluorooxyalkylene group-containing polymers described in JP-A No. 2012-72272,
fluorine-containing ether compounds described WO 2013/042732, WO 2013/121984, WO 2013/121985, WO 2013/121986, WO 2014/163004, JP-A No. 2014-080473, WO 2015/087902, WO 2017/038830, WO 2017/038832, WO 2017/187775, WO 2018/216630, WO 2019/039186, WO 2019/039226, WO 2019/039341, WO 2019/044479, WO 2019/049753, WO 2019/163282 and JP-A No. 2019-044158,
perfluoro (poly) ether-containing silane compounds described in JP-A No. 2014-218639, WO 2017/022437, WO 2018/079743 and WO 2018/143433,
perfluoro(poly)ether group-containing silane compounds described in WO 2018/169002,
fluoro(poly)ether group-containing silane compounds described in WO 2019/151442,
(poly)ether group-containing silane compounds described in WO 2019/151445,
perfluoropolyether group-containing compounds described in WO 2019/098230,
fluoropolyether group-containing polymer-modified silanes described in JP-A No. 2015-199906, JP-A No. 2016-204656, JP-A No. 2016-210854 and JP-A No. 2016-222859,
fluorine-containing compounds described in WO 2019/039083 and WO 2019/049754.

Examples of commercial products of the compound (A) include KY-100 series (KY-178, KY-185, KY-195, or the like) manufactured by Shin-Etsu Chemical Co., Ltd., Afluid (registered trademark) S550 manufactured by AGC Inc., OPTOOL (registered trademark), DSX, OPTOOL (registered trademark) AES, OPTOOL (registered trademark) UF503, OPTOOL (registered trademark) UD509 manufactured by Daikin Industries, Ltd.

A content of compound (A) in the surface treatment agent is preferably from 0.001 to 50% by mass, more preferably from 0.1 to 25% by mass, and still more preferably from 0.5 to 20% by mass. The content of compound (A) in the surface treatment agent may be 10% by mass or less, or may be 5% by mass or less.

<Compound (B)>

The compound (B) is a fluorine-containing aromatic compound represented by the following Formula (B). The compound (B) may be used singly, or in combination of two or more kinds thereof.

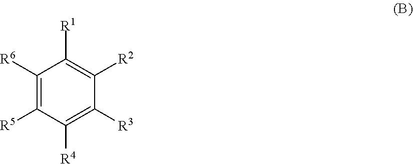

In Formula (B), each of R¹ to R⁶ independently represents a hydrogen atom, a fluorine atom, or a fluorine-containing alkyl group having from 1 to 3 carbon atoms, in which 0 to 3 members of R¹ to R⁶ are fluorine-containing alkyl groups, and the remaining members among R¹ to R⁶ represent hydrogen or fluorine atoms. Note that at least one of R¹ to R⁶ is a fluorine atom or a fluorine-containing alkyl group having from 1 to 3 carbon atoms.

Examples of fluorine-containing alkyl groups having from 1 to 3 carbon atoms represented by R¹ to R⁶ include a methyl group, an ethyl group, an n-propyl group, and an isopropyl group and at least a portion of the hydrogen atoms in these groups are fluorinated. Among them, from the viewpoint of availability, R¹ to R⁶ is preferably a methyl group in which at least a portion of hydrogen atoms are fluorinated, and more preferably a trifluoromethyl group.

In Formula (B), any combination of R¹ to R⁶ is preferably any combination in which one or two of R¹ to R⁶ are fluorine-containing alkyl groups and the remaining members among R¹ to R⁶ are hydrogen or fluorine atoms, more preferably any combination in which two of R¹ to R⁶ are fluorine-containing alkyl groups and the remaining members among R¹ to R⁶ are hydrogen atoms, and still more preferably any combination in which two of R¹ to R⁶ are trifluoromethyl groups and the remaining members among R¹ to R⁶ are hydrogen atoms.

A boiling point of the compound (B) at atmospheric pressure is preferably from 80 to 220° C., more preferably from 90 to 200° C., and still more preferably from 100 to 150° C.

Specific examples of the compound (B) are shown below. The numerical value described under each chemical formula means the boiling point at atmospheric pressure. In addition, Values marked with “*” are boiling points predicted by the Joback method.

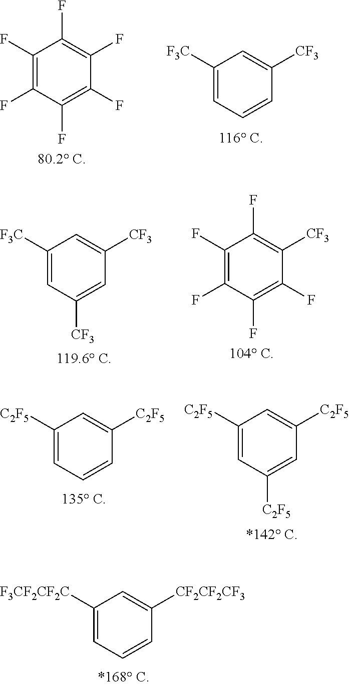

<Compound (C)>

The compound (C) is at least one compound selected from the group consisting of the compound (C1), the compound (C2), the compound (C3), the compound (C4) and the compound (C5). From the viewpoint of storage stability and film formability of the surface treatment agent, it is preferable to use at least one compound selected from the group consisting of the compound (C2), the compound (C3), the compound (C4) and the compound (C5).

A total content of the compound (B) and the compound (C) in the surface treatment agent is preferably from 50 to 99.999% by mass, more preferably from 75 to 99.9% by mass, and still more preferably from 85 to 99.5% by mass.

In one embodiment, a proportion of the compound (C1) in the compound (C) is preferably from 50 to 100% by mass, more preferably from 70 to 100% by mass, still more preferably from 90 to 100% by mass, and particularly preferably 100% by mass.

In another embodiment, a proportion of the compound (C2) in the compound (C) is preferably from 50 to 100% by mass, more preferably from 70 to 100% by mass, still more preferably from 90 to 100% by mass, and particularly preferably 100% by mass.

In another embodiment, a proportion of the compound (C3) in the compound (C) is preferably from 50 to 100% by mass, more preferably from 70 to 100% by mass, still more preferably from 90 to 100% by mass, and particularly preferably 100% by mass.

In another embodiment, a proportion of the compound (C4) in the compound (C) is preferably from 50 to 100% by mass, more preferably from 70 to 100% by mass, still more preferably from 90 to 100% by mass, and particularly preferably 100% by mass.

In another embodiment, a proportion of the compound (C5) in the compound (C) is preferably from 50 to 100% by mass, more preferably from 70 to 100% by mass, still more preferably from 90 to 100% by mass, and particularly preferably 100% by mass.

In one embodiment, a mass-based ratio (compound (B)/compound (C)) of the compound (B) to a total of the compound (C) is preferably from 5/95 to 90/10, more preferably from 10/90 to 88/12, and still more preferably from 15/85 to 85/15.

In another embodiment, the compound (C) includes the compound (C1), and a mass-based ratio (compound (B)/compound (C1)) of the compound (B) to the compound (C1) is preferably from 10/90 to 90/10, more preferably from 15/85 to 88/12, and still more preferably from 18/82 to 85/15.

In another embodiment, the compound (C) includes the compound (C2), a mass-based ratio (compound (B)/compound (C2)) of the compound (B) to the compound (C2) is preferably from 10/90 to 90/10, more preferably from 15/85 to 88/12, still more preferably from 18/82 to 85/15, particularly preferably from 20/80 to 75/25, and most preferably from 20/80 to 60/40.

In another embodiment, the compound (C) includes the compound (C3), and a mass-based ratio (compound (B)/compound (C3)) of the compound (B) to the compound (C3) is preferably from 12/88 to 90/10, more preferably from 15/85 to 88/12, and still more preferably from 18/82 to 85/15.

In another embodiment, the compound (C) includes the compound (C4), a mass-based ratio (compound (B)/compound (C4)) of the compound (B) to the compound (C4) is preferably from 10/90 to 90/10, more preferably from 15/85 to 88/12, still more preferably from 18/82 to 85/15, particularly preferably from 20/80 to 75/25, and most preferably from 20/80 to 60/40.

In another embodiment, the compound (C) includes the compound (C5), a mass-based ratio (compound (B)/compound (C5)) of the compound (B) to the compound (C5) is preferably from 10/90 to 90/10, more preferably from 15/85 to 88/12, still more preferably from 18/82 to 85/15, particularly preferably from 18/82 to 75/25, and most preferably from 18/82 to 60/40.

—Compound (C1)—

Compound (C1) is a fluorine-containing ketone compound represented by the following Formula (C1). Compound (C1) may be used singly, or in combination of two or more kinds thereof.

R⁷COR⁸ (C1)

In Formula (C1), each of R⁷ and R⁸ independently represents a linear, branched, or cyclic fluorine-containing alkyl group having from 1 to 5 carbon atoms.

A number of carbon atoms of the fluorine-containing alkyl group is preferably from 1 to 4, and more preferably from 1 to 3.

A fluorine atom content of Compound (C1) is preferably 50% by mole or more, more preferably 75% by mole or more, and still more preferably 100% by mole (i.e. perfluoroketone compound). The “fluorine atom content” means a proportion of hydrogen atoms contained in Compound (C1) substituted with fluorine atoms.

A boiling point of Compound (C1) at the atmospheric pressure is preferably from 50 to 220° C., more preferably from 60 to 200° C., and still more preferably from 70 to 180° C.

Specific examples of fluorine-containing alkyl groups represented by R⁷ and R⁸ include a methyl group, an ethyl group, an n-propyl group, an isopropyl group, a cyclopropyl group, an n-butyl group, an isobutyl group, a sec-butyl group, a tert-butyl group, a cyclobutyl group, an n-pentyl group, a neopentyl group an isopentyl group, a sec-pentyl group, a tert-pentyl group, a 1-ethylpropyl group, a 1,2-dimethylpropyl group, a cyclopentyl group, a cyclopropylmethyl group, a cyclobutylmethyl group, and a 2-cyclopropylethyl group, and at least a portion of the hydrogen atoms in these groups are fluorinated.

In a case in which the fluorine-containing alkyl group a cyclopropyl group, in which at least a portion of the hydrogen atoms are fluorinated, the cyclopropyl group may be substituted with one or two methyl group(s) or ethyl group(s) and at least a portion of the hydrogen atoms in methyl group(s) or ethyl group(s) are fluorinated.

In a case in which the fluorine-containing alkyl group is a cyclobutyl group, in which at least a portion of the hydrogen atoms are fluorinated, the cyclobutyl group may be substituted with one methyl group and at least a portion of the hydrogen atoms in the methyl group are fluorinated.

From the viewpoint of suppressing hydrolysis of Compound (C1), it is preferable that at least one fluorine-containing alkyl group represented by R⁷ or R⁸ in Formula (C1) is a branched fluorine-containing alkyl group, and it is more preferable that both of them are branched fluorine-containing alkyl groups.

In a case in which the fluorine-containing alkyl group is branched, the branching position of the fluorine-containing alkyl group is not particularly limited. From the viewpoint of suppressing hydrolysis of Compound (C1), it is preferable that the branched fluorine-containing alkyl group has a branched structure at α-carbon. In other words, from the viewpoint of further suppressing hydrolysis of Compound (C1), it is preferable that at least one fluorine-containing alkyl group represented by R⁷ or R⁸ in Formula (C1) is a fluorine-containing alkyl group having a branched structure at α-carbon, and it is more preferable that both of them are fluorine-containing alkyl groups having a branched structure at α-carbon.

As used herein, “α-carbon” of a fluorine-containing alkyl group refers to a carbon atom, which directly binds to a carbonyl group, among the carbon atoms contained in the fluorine-containing alkyl group. Examples of a fluorine-containing alkyl group having a branched structure at α-carbon include an isopropyl group, a sec-butyl group, and a tert-butyl group.

In a case in which two or more kinds of compounds (C1) are used in combination, the proportion of a compound (C1) in which at least one of R⁷ or R⁸ is a branched fluorine-containing alkyl group to all compounds (C1) is preferably from 50 to 100% by mass, more preferably from 80 to 100% by mass, and still more preferably from 90 to 100% by mass.

In a case in which two or more kinds of compounds (C1) are used in combination, the proportion of a compound (C1) in which both R⁷ and R⁸ are branched fluorine-containing alkyl groups to all compounds (C1) is preferably from 50 to 100% by mass, more preferably from 80 to 100% by mass, and still more preferably from 90 to 100% by mass.

Examples of a desired combination of fluorine-containing alkyl groups represented by R⁷ and R⁸ include any combination in which one of them is a fluorine-containing ethyl group, and the other is a fluorine-containing isopropyl group; any combination in which both of them are fluorine-containing isopropyl groups; any combination in which one of them is a fluorine-containing isopropyl group, and the other is a fluorine-containing n-propyl group; and any combination in which both of them are fluorine-containing sec-butyl groups from the viewpoint of suppressing hydrolysis and the viewpoint of solubility.

Specific examples of Compound (C1) are shown below.

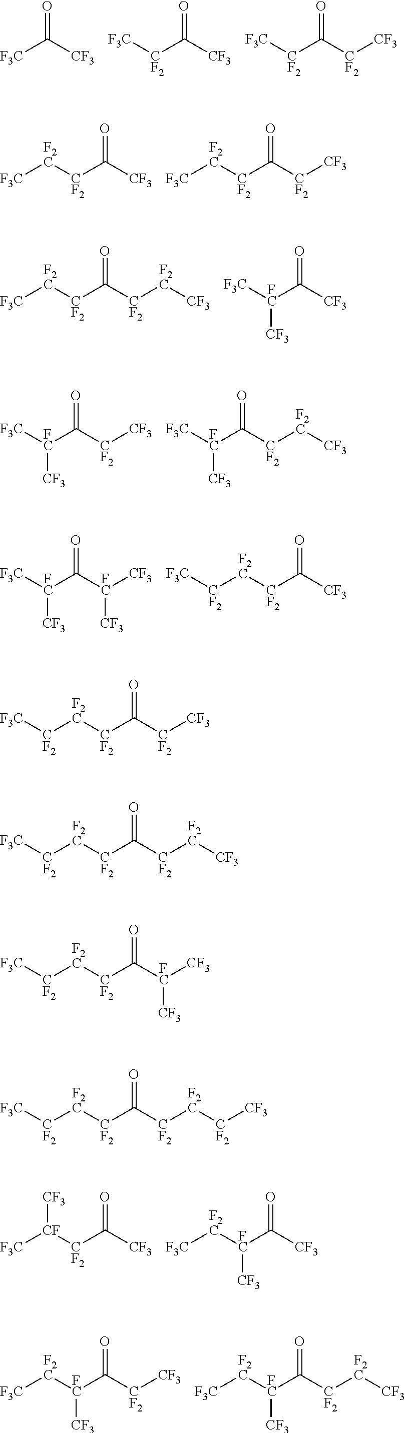

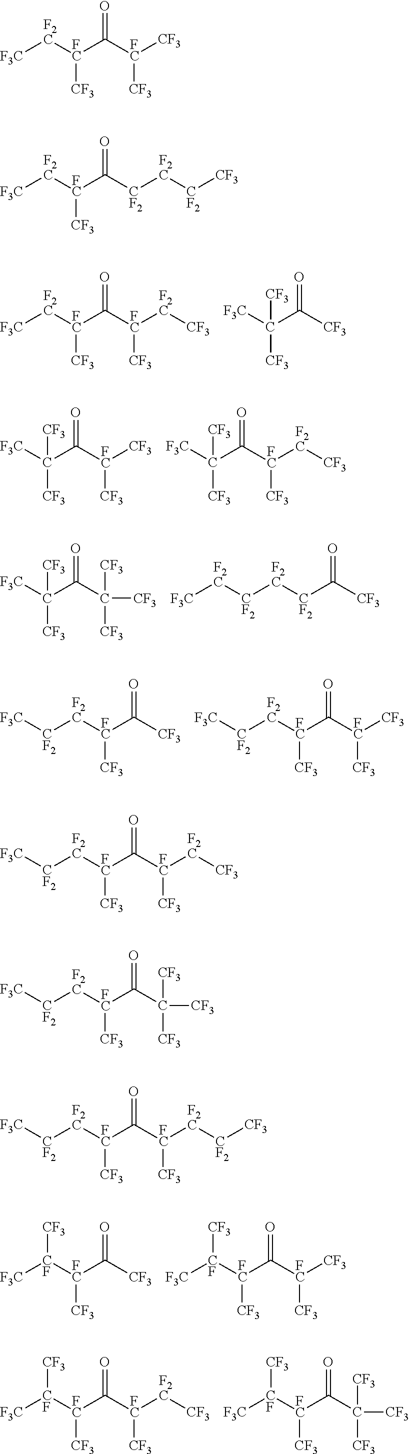

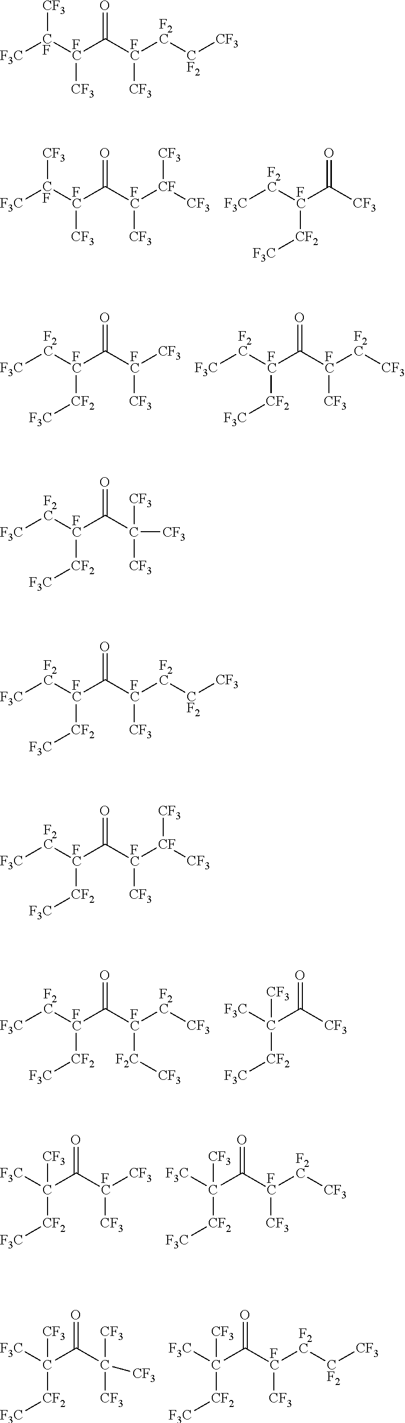

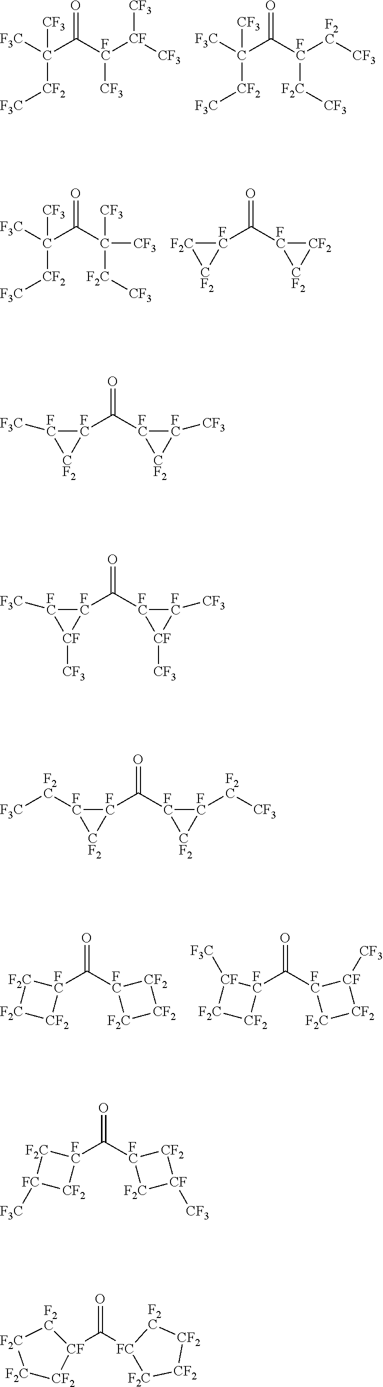

—Compound (C2)—

Compound (C2) is a fluorine-containing cyclic ketone compound represented by the following Formula (C2). Compound (C2) may be used singly, or in combination of two or more kinds thereof.

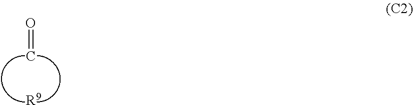

In Formula (C2), R⁹ represents a residue that forms a 3- to 5-membered ring structure with a carbon atom of a carbonyl group and that has a fluorine atom. R⁹ may be substituted with a fluorine-containing alkyl group having from 1 to 2 carbon atoms.

Specific examples of R⁹ include a dimethylene group, a trimethylene group, and a tetramethylene group and at least a portion of the hydrogen atoms in these groups are fluorinated.

A fluorine atom content of Compound (C2) is preferably 50% by mole or more, more preferably 75% by mole or more, and still more preferably 100% by mole (i.e. perfluorocyclic ketone compound).

A boiling point of Compound (C2) at the atmospheric pressure is preferably from 50 to 220° C., more preferably from 60 to 200° C., and still more preferably from 70 to 180° C.

Specific examples of Compound (C2) are shown below.

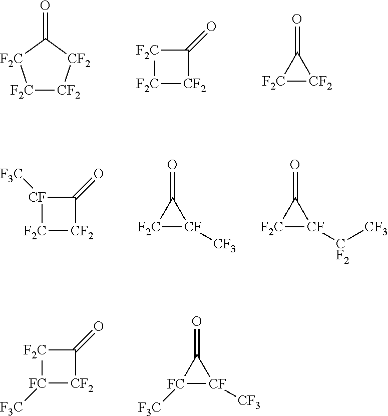

—Compound (C3)—

Compound (C3) is a fluorine-containing polyether compound represented by the following Formula (C3). Compound (C3) may be a mixture in which R¹⁰, R¹¹, and R¹² are the same and q has a distribution.

Compound (C3) may be used singly, or in combination of two or more kinds thereof. Using two or more kinds of Compounds (C3) means using plural Compounds (C3) in which at least one of R¹⁰, R¹¹, or R¹² is different from each other.

R¹⁰—[OR¹¹]_{q}—R¹² (C3)

In Formula (C3), each of R¹⁰ and R¹² independently represents a fluorine-containing alkyl group having from 1 to 3 carbon atoms, q represents an integer of 1 or more, Ru represents a perfluoroalkylene group having from 1 to 6 carbon atoms, and in a case in which q is an integer of 2 or more, plural R¹¹s may be the same or different. In a case in which plural R¹¹s are different, the binding order of [OR¹¹] is not limited and may be arranged randomly, alternately, or in blocks.

A fluorine atom content of Compound (C3) is preferably 50% by mole or more, more preferably 75% by mole or more, and still more preferably 100% by mole (i.e. perfluoropolyether compound).

A boiling point of Compound (C3) at the atmospheric pressure is preferably from 50 to 220° C., more preferably from 60 to 200° C., and still more preferably from 70 to 180° C. from the viewpoint of handleability of the surface treatment agent.

A number average molecular weight of Compound (C3) is preferably from 300 to 1,000, more preferably from 400 to 990, and still more preferably from 450 to 980 from the viewpoint of availability of the surface treatment agent.

A kinetic viscosity of Compound (C3) at 25° C. is preferably from 0.01 to 500 cSt (from 1×10⁻⁸ to 5×10⁻⁴ m²/s), more preferably from 0.05 to 100 cSt (from 5×10⁻⁸ to 1×10⁻⁴ m²/s), and still more preferably from 0.1 to 80 cSt (from 1×10⁻⁷ to 8×10⁻⁵ m²/s) from the viewpoint of handleability of the surface treatment agent. The kinetic viscosity in the present disclosure is measured in accordance with JIS K 2283:2000.

Specific examples of fluorine-containing alkyl groups represented by R¹⁰ and R¹² include a methyl group, an ethyl group, an n-propyl group, and an isopropyl group and at least a portion of the hydrogen atoms in these groups are fluorinated.

Specific examples of a perfluoroalkylene group represented by R¹¹ include a methylene group, ethylene group, trimethylene group, propylidene group, isopropylidene group and propylene group, and these groups are perfluorinated; —(CF₂)₄—, —(CF₂)₅—; and —(CF₂)₆—.

In a case in which q is an integer of 2 or more and plural R¹¹s are the same in Formula (C3), R¹¹ is preferably a perfluoropropylene group (—OCF(CF₃)CF₂— or —OCF₂CF(CF₃)— as [—OR¹¹—]) or the like.

In a case in which q is an integer of 2 or more and plural R¹¹s are different in Formula (C3), examples of a combination of R¹¹s include any combination of a perfluoromethylene group and a perfluoroethylene group; any combination of a perfluoropropylene group and a perfluoromethylene group; any combination of a perfluoroethylene group and —(CF₂)₄—; and any combination of a perfluoroethylene group and —(CF₂)₆—.

Examples of a combination of R¹⁰, R¹, and R¹² in Formula (C3) include any combination in which both R¹⁰ and R¹² are trifluoromethyl groups and R¹¹s are a perfluoromethylene group and a perfluoropropylene group; any combination in which both R¹⁰ and R¹² are difluoromethyl groups and R¹¹s are a perfluoromethylene group and a perfluoropropylene group; any combination in which R¹⁰ is a perfluoro-n-propyl group, R¹¹ is a perfluoropropylene group, and R¹² is a tetrafluoroethyl group; any combination in which R¹⁰ is a perfluoro-n-propyl group, R¹¹ is a perfluoropropylene group, and R¹² is a perfluoroethyl group; and any combination in which both R¹⁰ and R¹² are perfluoro-n-propyl groups and R¹¹ is a perfluoropropylene group.

—Compound (C4)—

The compound (C4) is a hydrofluoroolefin having from 3 to 8 carbon atoms, preferably a hydrofluoroolefin having from 4 to 7 carbon atoms, and more preferably a hydrofluoroolefin having from 5 to 7 carbon atoms. The compound (C4) may be used singly, or in combination of two or more kinds thereof. A hydrofluoroolefin refers to a compound having a carbon-carbon double bond and composed of carbon atom, fluorine atom, and hydrogen atom.

A boiling point of the compound (C4) at atmospheric pressure is preferably from 10 to 220° C., more preferably from 20 to 180° C., and still more preferably from 40 to 160° C.

The compound (C4) is preferably at least one selected from the group consisting of (E)-1,1,1,4,4,4-hexafluoro-2-butene (HFO-1336mzz-E), (Z)-1,1,1,4,4,4-hexafluoro-2-butene (HFO-1336mzz-Z), 2,4,4,4-tetrafluoro-1-butene (HFO-1354myf), (E)-1,1,1,3-tetrafluoro-2-butene (HFO-1354mzy-E), 1,3,3,4,4,5,5-heptafluorocyclopentene, 3,3,4,4,5,5-hexafluorocyclopentene, (E)-1,1,1,4,4,5,5,5-octafluoro-2-pentene (HFO-1438mzz-E), and 1,1,1,2,2,5,5,6,6,7,7,7-dodecafluoro-3-heptene (CF₃CF₂CF₂CH═CHCF₂CF₃), more preferably at least one selected from the group consisting of 1,3,3,4,4,5,5-heptafluorocyclopentene, 3,3,4,4,5,5-hexafluorocyclopentene, (E)-1,1,1,4,4,5,5,5-octafluoro-2-pentene (HFO-1438mzz-E), and 1,1,1,2,2,5,5,6,6,7,7,7-dodecafluoro-3-heptene, still more preferably at least one selected from the group consisting of (E)-1,1,1,4,4,5,5,5-octafluoro-2-pentene (HFO-1438mzz-E) and 1,1,1,2,2,5,5,6,6,7,7,7-dodecafluoro-3-heptene.

—Compound (C5)—

The compound (C5) is a hydrochlorofluoroolefin having from 3 to 8 carbon atoms, preferably a hydrochlorofluoroolefin having 4 or 5 carbon atoms, more preferably a hydrochlorofluoroolefin having 4 carbon atoms. The compound (C5) may be used singly, or in combination of two or more kinds thereof. A hydrochlorofluoroolefin refers to a compound having a carbon-carbon double bond and composed of carbon atom, chlorine atom, fluorine atom, and hydrogen atom.

A boiling point of the compound (C5) at atmospheric pressure is preferably from 20 to 200° C., more preferably from 30 to 160° C., and still more preferably from 40 to 150° C.

The compound (C5) is preferably at least one selected from the group consisting of (Z)-1-chloro-3,3,3-trifluoropropene (HCFO-1233zdZ), (E)-1-chloro-3,3,3-trifluoropropene (HCFO-1233zdE), (Z)-1-chloro-2,3,3-trifluoropropene (HCFO-1233ydZ), 1,3-dichloro-2,3,3-trifluoropropene (HCFO-1223yd), (Z)-1-chloro-2,3,3,3-tetrafluoropropene (HCFO-1224ydZ), 1-chloro-2,3,3,4,4,5,5-heptafluorocyclopentene, 1,3-dichloro-2,3,3-trifluoropropene (HCFO-1223yd), 1,2-dichloro-3,3-difluoropropene (HCFO-1232xd), and 1,2-dichloro-3,3,3-trifluoropropene (HCFO-1223xd), more preferably at least one selected from the group consisting of (Z)-1-chloro-3,3,3-trifluoropropene (HCFO-1233zdZ), (E)-1-chloro-3,3,3-trifluoropropene (HCFO-1233zdE), (Z)-1-chloro-2,3,3-trifluoropropene (HCFO-1233ydZ), 1,3-dichloro-2,3,3-trifluoropropene (HCFO-1223yd), 1,3-dichloro-2,3,3-trifluoropropene (HCFO-1223yd), and 1,2-dichloro-3,3,3-trifluoropropene (HCFO-1223xd), and still more preferably at least one selected from the group consisting of (Z)-1-chloro-3,3,3-trifluoropropene (HCFO-1233zdZ), (E)-1-chloro-3,3,3-trifluoropropene (HCFO-1233zdE), and (Z)-1-chloro-2,3,3-trifluoropropene (HCFO-1233ydZ).

<Other Components>

The surface treatment agent in the present disclosure may contain components other than the compound (A), the compound (B) and the compound (C) within a scope in which the purpose of the present disclosure is not impaired, and stability, performance, appearance and the like are not adversely affected.

Examples of other components include other solvent components other than the compound (B) and the compound (C), a pH adjuster for preventing coating surface corrosion, an anticorrosion agent, an antifungal agent, a dye, a pigment, a UV absorber, and an antistatic agent. Other solvent components include dichloroethylene.

A contents of other solvent components in the surface treatment agent is preferably 80% by mass or less, more preferably 70% by mass or less, still more preferably 60% by mass or less, particularly preferably 30% by mass or less, and most preferably 10% by mass or less.

A contents of other components other than other solvent components in the surface treatment agent is preferably 5% by mass or less, more preferably 1% by mass or less, and still more preferably 0.5% by mass or less.

[Method of Producing Substrate Having Surface-Treated Layer]

A method of producing a substrate having a surface-treated layer in the present disclosure is not particularly limited as long as a surface-treated layer is formed using the surface treatment agent in the present disclosure. Examples of a method of forming a surface-treated layer on a substrate include a dry coating method and a wet coating method.

(Substrate)

A substrate to be used in the present disclosure is not particularly limited as long as it is a substrate that requires water and oil repellency. A material of the substrate is not particularly limited. Examples of the surface material of the substrate include a metal, a resin, a glass, a ceramic, or a composite material thereof.

(Dry Coating Method)

The surface treatment agent in the present disclosure may be used as is in a method of producing a substrate having a surface-treated layer by treating a surface of a substrate by a dry coating method. The surface treatment agent in the present disclosure is preferable for forming a surface-treated layer having excellent adhesiveness by the dry coating method.

Examples of the dry coating method include vacuum deposition, CVD, and sputtering methods. The vacuum deposition method may be preferably used from the viewpoint of suppressing the decomposition of the compound (A) contained in the surface treatment agent in the present disclosure and the viewpoint of the convenience of the system. The vacuum deposition method may be subdivided into the resistance heating method, the electron beam heating method, the high frequency induction heating method, the reactive vapor deposition, the molecular beam epitaxy method, the hot wall vapor deposition method, the ion plating method, and the cluster ion beam method, any of which may be applied. The resistance heating method may be preferably used from the viewpoint of suppressing the decomposition of the compound (A) contained in the surface treatment agent in the present disclosure and the viewpoint of the convenience of the system. The vacuum deposition system is not particularly limited, and a known system may be used.

In a case in which the dry coating method is carried out using a vacuum deposition system, the surface treatment agent containing the compound (A) is placed in an appropriate container and heated to be evaporated. Examples of a preferable container include a porous material. A porous material is impregnated with the surface treatment agent and heated, which results in a moderate vapor deposition rate. Examples of a porous material that may be used include, but are not particularly limited to, a sintered filter made by sintering a metal powder having a high thermal conductivity, such as copper. By using the surface treatment agent in the present disclosure when forming a surface treatment layer by a dry coating method, an amount of evaporation of the compound (A) to be evaporated may be precisely adjusted, whereby it possible to control the film thickness of the surface-treated layer.

In a case in which the vacuum deposition method is used, film formation conditions vary depending on the type of the vacuum deposition method to be applied. In the case in which the resistance heating method is used, a degree of vacuum before vapor deposition is preferably 1×10⁻² Pa or less, and more preferably 1×10⁻³ Pa or less. A heating temperature of an evaporation source is not particularly limited as long as the compound (A) is at a temperature at which the steam pressure is sufficient. Specifically, it is from 30 to 400° C., and more preferably from 50 to 300° C. In a case in which the heating temperature is equal to or more than the lower limit of this range, a film formation speed is favorable. In a case in which the heating temperature is equal to or less than the upper limit of this range, water and oil repellency and abrasion resistance may be imparted to a surface of a substrate without causing the decomposition of the compound (A). A substrate temperature is preferably in a range of from room temperature (25° C.) to 200° C. during vacuum deposition. In a case in which the substrate temperature is 200° C. or less, the film formation speed is favorable. An upper limit of the substrate temperature is more preferably 150° C. or less, and still more preferably 100° C. or less.

In a case in which a surface of a substrate is treated by the dry coating method using the surface treatment agent in the present disclosure, a film thickness of a surface-treated layer formed on the surface of the substrate by the treatment is preferably from 1 to 100 nm, and more preferably from 1 to 50 nm. In a case in which the film thickness of the surface-treated layer is equal to or more than the lower limit of this range, it is possible to easily obtain the sufficient effects of the surface treatment. In a case in which the film thickness of the surface-treated layer is equal to or less than the upper limit of the range, the utilization efficiency is high. The film thickness may be calculated from the oscillation period of interference patterns of reflected X-rays obtained by X-ray reflectometry using, for example, a X-ray diffractometer for thin film analysis ATX-G (manufactured by Rigaku Corporation).

In particular, in the vacuum deposition method, a surface-treated layer having excellent water and oil repellency and abrasion resistance may be formed as the content of the compound (A) is high while a content of impurities is low. This is considered to be due to suppressing the phenomenon that chemical bonding between the compound (A) responsible for the appearance of performance and the surface of the substrate is hindered because, according to the vacuum deposition method, a by-product having a small vapor pressure deposits on the surface of the substrate before the compound (A).

(Wet Coating Method)

The substrate having a surface-treated layer may be produced by coating a surface of a substrate with the surface treatment agent in the present disclosure, and drying the surface treatment agent.

As the method of coating with the surface treatment agent, a known method is used, if appropriate.

As the coating method, a spin coating method, a wipe coating method, a spray coating method, a squeegee coating method, a dip coating method, a die coating method, a inkjet method, a flow coating method, a roll coating method, a casting method, a Langmuir-Blodgett method, or a gravure coating method is preferable.

A drying method may be a method capable of removing the compound (B) and the compound (C) contained in the surface treatment agent by drying, and a known method is used as appropriate. A drying temperature is preferably from 10 to 300° C., and more preferably from 20 to 200° C.

A film thickness of a surface-treated layer formed on the surface of the substrate after drying and removing the compound (B) and the compound (C) is preferably from 1 to 100 nm, and more preferably from 1 to 50 nm. In a case in which the film thickness of the surface-treated layer is equal to or more than the lower limit of this range, it is possible to easily obtain the sufficient effects of the surface treatment. In a case in which the film thickness of the surface-treated layer is equal to or less than the upper limit of the range, the utilization efficiency is high. The film thickness may be measured in the same manner as the film thickness of a surface-treated layer formed by the dry coating method.

(Aftertreatment)

After forming a surface-treated layer on a surface of a substrate by the dry coating method or the wet coating method, an operation for promoting a reaction between the compound (A) and the substrate may be performed, if necessary, in order to improve abrasion resistance of the surface-treated layer. The operation includes heating, humidification, light irradiation, and the like. For example, by heating the substrate on which the surface-treated layer is formed in an atmosphere containing moisture, reactions, which are a hydrolysis reaction of hydrolyzable silyl groups to silanol groups, a reaction between hydroxyl groups and the like and silanol groups on the substrate surface, and a reaction such as the formation of siloxane bonds due to the condensation reaction of silanol groups, may be accelerated.

After the surface treatment, compounds in the surface-treated layer, which are not chemically bonded to the other compounds or the substrate, may be removed, if necessary. Examples of specific methods thereof include a method of pouring a solvent over the surface-treated layer and a method of wiping with a cloth soaked in a solvent.

A water contact angle of the surface-treated layer by the θ/2 method is preferably from 80 to 120°, more preferably from 100 to 120°, and still more preferably 105 to 120°.

### Example

Hereinafter, the above embodiments will be described in detail with reference to examples, but the above embodiments are not limited to these examples.

Examples 1, 17 and 24 are comparative examples, and Examples 2 to 16, 18 to 23 and 25 to 30 are examples.

<Preparation of Compound (A1)>

The following compound (A1) was obtained according to the method described in Example 15 of Japanese Patent No. 5761305.

CF₃(OCF₂CF₂)₁₅(OCF₂)₁₆OCF₂CH₂OCH₂CH₂CH₂Si[CH₂CH₂CH₂Si(OCH₃)₃]₃ (A1)

Mn of compound (A1): 3,600

<Preparation of Compound (A2)>

The following compound (A2) was obtained according to the method described in Synthesis Example 16-3 of WO 2017/038830.

CF₃CF₂CF₂—O—(CF₂CF₂O)(CF₂CF₂O)[(CF₂O)ₓ₁(CF₂CF₂O)ₓ₂]—CF₂—C(O)NH—CH₂—C[CH₂CH₂CH₂—Si(OCH₃)₃]₃ (A2)

Mn of compound (A2): 4,500

<Preparation of Compound (A3)>

The following compound (A3) was obtained according to the method described in Synthesis Example 1 of WO 2018/043166.

CF₃O(CF₂CF₂OCF₂CF₂CF₂CF₂O)ₘ₂₅CF₂CF₂OCF₂CF₂CF₂—C(═O)N[CH₂CH₂CH₂Si(OCH₃)₃]₂ (A3)

Mn of compound (A3): 4,500

<Preparation of Surface Treatment Agent>

The compound (A1) was diluted with each of the mixtures obtained by mixing the compound (B) with the compounds (C) listed in Table 1 at mass-based ratios described in Table 1 such that the concentration of the compound (A1) resulted in 1% by mass, thereby preparing surface treatment agents of Examples 1 to 16. In addition, the compound (A2) or (A3) was diluted with each of the mixtures obtained by mixing the compound (B) with the compounds (C) listed in Table 2 at mass-based ratios described in Table 2 such that the concentration of the compound (A2) or (A3) resulted in 1% by mass, thereby preparing surface treatment agents of Examples 17 to 30. The compound (B) and the compound (C) used in Examples 1 to 30 are as follows.
B: 1,3-bis(trifluoromethyl) benzene
C-1: (Z)-1-chloro-2,3,3-trifluoropropene
C-2: Mixture of (CF₃)₂CFC(═O)CF₂CF₃ and CF₃CF₂CF₂C(═O)CF₂CF₃ of 98:2 by mass
C-3: Mixture (CF₃)₂CFC(═O)CF(CF₃)₂ and CF₃CF₂CF₂C(═O)CF(CF₃)₂ of 91:9 by mass
C-4: CF₃—[OCF(CF₃)CF₂)_{q1}(OCF₂)_{q2}]—CF₃ (boiling point: 110° C., kinematic viscosity at 25° C.: 0.8 cSt (8×10⁴ m2/s), number average molecular weight: 494, and q1 and q2 are integers of 1 or more)
C-5: Perfluorocyclopentanone
C-6: 1,1,1,2,2,5,5,6,6,7,7,7-dodecafluoro-3-heptene (CF₃CF₂CF₂CH═CHCF₂CF₃)

<Formation of Surface-Treated Layer>

The Si substrate was immersed in a mixed solution of concentrated sulfuric acid/hydrogen peroxide water (35% concentration aqueous solution) (3/1, v/v) at 90° C. for 30 minutes in a glass petri dish. Then, the Si substrate was taken out and washed with distilled water, thereby forming a chemical oxide film-formed Si substrate. Subsequently, the chemical oxide film-formed Si substrate was immersed in a surface treatment agent (a solid content concentration is 1% by mass, and the solid content concentration represents an evaporation residue when heated at 120° C., which is the percent (%) by mass with respect to the surface treatment agent before heating) at 25° C. for 1 hour in a stainless steel petri dish. Thereafter, the Si substrate was taken out and baked at 140° C. for 30 minutes using a hot plate. Lastly, the substrate was washed with a fluorine-based solvent ASAHIKLIN AE-3000 (1,1,2,2-tetrafluoroethyl-2,2,2-trifluoroethyl ether, manufactured by AGC Inc.), thereby forming a Si substrate having a surface-treated layer formed thereon.

<Evaluation>

Film formability, water contact angle and storage stability were evaluated by the methods described below.

### (Film Formability)

An appearance of the Si substrate on which the surface-treated layer was formed was visually confirmed according to the following criteria. The obtained results are shown in Tables 1 and 2.

Cloudiness is observed on the substrate by visual inspection: C; Cloudiness is partially observed: B; Cloudiness is not observed: A.

In addition, the film formability was confirmed using an optical microscope (DSX10-UZH, Olympus Corporation) and evaluated according to the following criteria. Measurements were taken using a reflection method at a magnification of five times. The obtained results are shown in Tables 1 and 2.

Radial unevenness is observed: B; Radial unevenness is not observed: A.

Mottled pattern is observed: B; Mottled pattern is not observed: A.

(Water Contact Angle)

First, the surface of the surface-treated layer of the Si substrate on which the surface-treated layer was formed was wiped off and cleaned with BEMCOT (registered trademark) impregnated with ethanol. Then, a contact angle of about 2 μL of distilled water placed on the surface of the surface-treated layer was measured at 20° C. using a contact angle measurement device (DM-701 manufactured by Kyowa Interface Science Co., Ltd). Measurements were taken at five different points on the surface of the surface-treated layer, and the average value of the measurements was calculated, thereby obtaining the water contact angle. The θ/2 method was used for calculating the water contact angle. The obtained results are shown in Tables 1 and 2.

(Storage Stability)

The surface treatment agent obtained as described above was allowed to stand at 25° C. for 30 days, and the presence or absence of phase separation after standing was checked and evaluated according to the following criteria. The obtained results are shown in Tables 1 and 2.

Phase separation occurred: C; No phase separation occurred, but turbidity occurred: B; Solution remained homogeneous: A.

TABLE 1

| | | | | | | | Optical | Optical |
|---|---|---|---|---|---|---|---|---|
| | | | Compound (B)/ | | Film | Water | Microscope | Microscope |
| | Compound | Compound | Compound (C) | Storage | Formability | Contact | (Radial | (Mottled |
| | (B) | (C) | (based on mass) | Stability | (Appearance) | Angle | Unevenness) | Pattern) |
| Example 1 | B | — | 100 | C | C | 112.6° | B | B |
| Example 2 | B | C-1 | 50/50 | B | B | 113.4° | B | A |
| Example 3 | B | C-1 | 20/80 | B | B | 113.6° | B | A |
| Example 4 | B | C-2 | 50/50 | A | A | 113.9° | A | A |
| Example 5 | B | C-2 | 30/70 | A | A | 113.7º | A | A |
| Example 6 | B | C-2 | 70/30 | A | A | 114.1º | A | A |
| Example 7 | B | C-3 | 50/50 | A | A | 114.3° | A | A |
| Example 8 | B | C-3 | 80/20 | A | A | 114.6° | A | A |
| Example 9 | B | C-3 | 20/80 | A | A | 114.2° | A | A |
| Example 10 | B | C-4 | 50/50 | A | A | 113.4º | A | A |
| Example 11 | B | C-4 | 80/20 | A | A | 113.7° | A | A |
| Example 12 | B | C-4 | 20/80 | A | A | 113.6° | A | A |
| Example 13 | B | C-5 | 50/50 | A | A | 114.2° | A | A |
| Example 14 | B | C-5 | 25/75 | A | A | 113.9º | A | A |
| Example 15 | B | C-6 | 50/50 | A | A | 113.8° | A | A |
| Example 16 | B | C-6 | 25/75 | A | A | 114.1° | A | A |

As is clear from the evaluation results shown in Table 1, it is understood that the surface-treated layers of Examples 2 to 16 are superior to the surface-treated layer of Example 1 in the observation results of the surface properties by visual observation and optical microscope observation. From these results, it may be said that the surface-treated layers of Examples 2 to 16 are excellent in flatness.

As is clear from the evaluation results shown in Table 1, it is understood that the surface-treated layers of Examples 2 to 16 are superior to the surface-treated layer of Example 1 in storage stability.

TABLE 2

| | | | | | | | | Optical | Optical |
|---|---|---|---|---|---|---|---|---|---|
| | | | | | | Film | Water | Microscope | Microscope |
| | Compound | Compound | Compound | | Storage | Formability | Contact | (Radial | (Mottled |
| | (A) | (B) | (C) | (B)/(C) | Stability | (Appearance) | Angle | Unevenness) | Pattern) |
| Example 17 | A2 | B | — | 100 | C | C | 113.3° | B | B |
| Example 18 | A2 | B | C-1 | 50/50 | B | B | 114.0° | B | A |
| Example 19 | A2 | B | C-2 | 50/50 | A | A | 113.5° | A | A |
| Example 20 | A2 | B | C-3 | 50/50 | A | A | 113.6° | A | A |
| Example 21 | A2 | B | C-4 | 50/50 | A | A | 114.1º | A | A |
| Example 22 | A2 | B | C-5 | 50/50 | A | A | 113.9º | A | A |
| Example 23 | A2 | B | C-6 | 50/50 | A | A | 113.8° | A | A |
| Example 24 | A3 | B | — | 100 | C | C | 113.7º | B | B |
| Example 25 | A3 | B | C-1 | 50/50 | B | B | 113.5° | B | A |
| Example 26 | A3 | B | C-2 | 50/50 | A | A | 113.6° | A | A |
| Example 27 | A3 | B | C-3 | 50/50 | A | A | 113.6° | A | A |
| Example 28 | A3 | B | C-4 | 50/50 | A | A | 113.8° | A | A |
| Example 29 | A3 | B | C-5 | 50/50 | A | A | 113.9º | A | A |
| Example 30 | A3 | B | C-6 | 50/50 | A | A | 114.2° | A | A |

In Table 2, “(B)/(C)” indicates a blending ratio of the compound (B) and the compound (C) on a mass basis.

As is clear from the evaluation results shown in Table 2, it is understood that the surface-treated layers of Examples 18 to 23 are superior to the surface-treated layer of Example 17 in the observation results of the surface properties by visual observation and optical microscope observation. The same is true for Examples 25 to 30 compared to Example 24. From these results, it may be said that the surface-treated layers of Examples 18 to 23 and 25 to 30 are excellent in flatness.

The entire contents of the disclosures by Japanese Patent Application No. 2021-044130 filed on Mar. 17, 2021 are incorporated herein by reference.

All publications, patent applications, and technical standards mentioned in this specification are herein incorporated by reference to the same extent as if each individual publication, patent application, or technical standard was specifically and individually indicated to be incorporated by reference.

1. A surface treatment agent, comprising:
a fluorine-containing compound (A) having a reactive silyl group;
a fluorine-containing aromatic compound (B) represented by the following Formula (B); and
at least one compound (C) selected from the group consisting of a fluorine-containing ketone compound (C1) represented by the following Formula (C1), a fluorine-containing cyclic ketone compound (C2) represented by the following Formula (C2), a fluorine-containing polyether compound (C3) represented by the following Formula (C3), a hydrofluoroolefin (C4) having from 3 to 8 carbon atoms, and a hydrochlorofluoroolefin (C5) having from 3 to 8 carbon atoms: 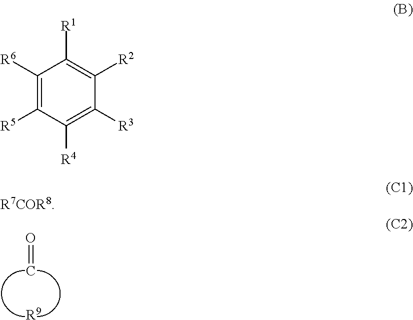
R¹⁰—[OR¹¹]_{q}—R¹² (C3)
wherein, in Formula (B), each of R¹ to R⁶ independently represents a hydrogen atom, a fluorine atom, or a fluorine-containing alkyl group having from 1 to 3 carbon atoms, 0 to 3 members of R¹ to R⁶ are fluorine-containing alkyl groups, and remaining members among R¹ to R⁶ represent hydrogen or fluorine atoms, and at least one of R¹ to R⁶ is a fluorine atom or a fluorine-containing alkyl group having from 1 to 3 carbon atoms,
in Formula (C1), each of R⁷ and R⁸ independently represents a linear, branched, or cyclic fluorine-containing alkyl group having from 1 to 5 carbon atoms,
in Formula (C2), R⁹ represents a residue that forms a 3- to 5-membered ring structure with a carbon atom of a carbonyl group and that has a fluorine atom, and R⁹ may be substituted with a fluorine-containing alkyl group having from 1 to 2 carbon atoms, and
in Formula (C3), each of R¹⁰ and R¹² independently represents a fluorine-containing alkyl group having from 1 to 3 carbon atoms, q represents an integer of 1 or more, R¹¹ represents a perfluoroalkylene group having from 1 to 6 carbon atoms, and in a case in which q is an integer of 2 or more, a plurality of R¹¹s may be the same or different.

2. The surface treatment agent according to claim 1, wherein a boiling point of the fluorine-containing aromatic compound (B) at atmospheric pressure is from 80 to 220° C.

3. The surface treatment agent according to claim 1, wherein a mass-based ratio of the fluorine-containing aromatic compound (B) to a total of the compound (C) is from 5/95 to 90/10.

4. The surface treatment agent according to claim 1, wherein
the compound (C) comprises the fluorine-containing ketone compound (C1), and
a mass-based ratio of the fluorine-containing aromatic compound (B) to the fluorine-containing ketone compound (C1) is from 10/90 to 90/10.

5. The surface treatment agent according to claim 1, wherein:
the compound (C) comprises the fluorine-containing cyclic ketone compound (C2), and
a mass-based ratio of the fluorine-containing aromatic compound (B) to the fluorine-containing cyclic ketone compound (C2) is from 10/90 to 90/10.

6. The surface treatment agent according to claim 1, wherein:
the compound (C) comprises the fluorine-containing polyether compound (C3), and
a mass-based ratio of the fluorine-containing aromatic compound (B) to the fluorine-containing polyether compound (C3) is from 12/88 to 90/10.

7. The surface treatment agent according to claim 1, wherein:
the compound (C) comprises the hydrofluoroolefin (C4), and
a mass-based ratio of the fluorine-containing aromatic compound (B) to the hydrofluoroolefin (C4) is from 10/90 to 90/10.

8. The surface treatment agent according to claim 1, wherein:
the compound (C) comprises the hydrochlorofluoroolefin (C5), and
a mass-based ratio of the fluorine-containing aromatic compound (B) to the hydrochlorofluoroolefin (C5) is from 10/90 to 90/10.

9. The surface treatment agent according to claim 1, wherein at least one fluorine-containing alkyl group represented by R⁷ or R⁸ in Formula (C1) is a branched fluorine-containing alkyl group.

10. The surface treatment agent according to claim 9, wherein both fluorine-containing alkyl groups represented by R⁷ and R⁸ in Formula (C1) are branched fluorine-containing alkyl groups.

11. The surface treatment agent according to claim 9, wherein the branched fluorine-containing alkyl group has a branched structure at α-carbon.

12. The surface treatment agent according to claim 1, wherein a boiling point of the fluorine-containing polyether compound (C3) at atmospheric pressure is from 50 to 220° C.

13. The surface treatment agent according to claim 1, wherein a number average molecular weight of the fluorine-containing polyether compound (C3) is from 300 to 1,000.

14. The surface treatment agent according to claim 1, wherein the fluorine-containing polyether compound (C3) comprises a perfluoropolyether compound.

15. The surface treatment agent according to claim 1, wherein the fluorine-containing ketone compound (C1) comprises a perfluoroketone compound.

16. The surface treatment agent according to claim 1, wherein the fluorine-containing cyclic ketone compound (C2) comprises a perfluorocyclic ketone compound.

17. The surface treatment agent according to claim 1, wherein the hydrofluoroolefin (C4) is at least one selected from the group consisting of (E)-1,1,1,4,4,4-hexafluoro-2-butene, (Z)-1,1,1,4,4,4-hexafluoro-2-butene, 2,4,4,4-tetrafluoro-1-butene, (E)-1,1,1,3-tetrafluoro-2-butene, 1,3,3,4,4,5,5-heptafluorocyclopentene, 3,3,4,4,5,5-hexafluorocyclopentene, (E)-1,1,1,4,4,5,5,5-octafluoro-2-pentene, and 1,1,1,2,2,5,5,6,6,7,7,7-dodecafluoro-3-heptene.

18. The surface treatment agent according to claim 1, wherein the hydrochlorofluoroolefin (C5) is at least one selected from the group consisting of (Z)-1-chloro-3,3,3-trifluoropropene, (E)-1-chloro-3,3,3-trifluoropropene, (Z)-1-chloro-2,3,3-trifluoropropene, 1,3-dichloro-2,3,3-trifluoropropene, (Z)-1-chloro-2,3,3,3-tetrafluoropropene, 1-chloro-2,3,3,4,4,5,5-heptafluorocyclopentene, 1,3-dichloro-2,3,3-trifluoropropene, 1,2-dichloro-3,3-difluoropropene, and 1,2-dichloro-3,3,3-trifluoropropene.

19. A method of producing a substrate having a surface-treated layer; comprising:
coating a surface of a substrate with the surface treatment agent according to claim 1; and
drying the surface treatment agent.

20. The method of producing a substrate having a surface-treated layer according to claim 19, wherein a surface material of the substrate is a metal, a resin, a glass, a ceramic, or a composite material thereof.
